(19) United States
(12) Patent Application Publication
(10) Pub. No.: US 2005/0164794 A1
(43) Pub. Date: Jul. 28, 2005

(54) Game system using touch panel input

(75) Inventor: Kouzou Tahara, Kyoto-shi (JP)

Correspondence Address: NIXON & VANDERHYE, PC, 901 NORTH GLEBE ROAD, 11TH FLOOR, ARLINGTON, VA, 22203, US

(73) Assignee: Nintendo Co.,, Ltd., Kyoto (JP)

(21) Appl. No.: 10/928,344

(22) Filed: Aug. 30, 2004

(30) Foreign Application Priority Data
Jan. 28, 2004 (JP) 2004-020485

(51) Int. Cl. A63F 13/00

(52) U.S. Cl. 463/43

(57) ABSTRACT

On a display screen, a game image, which contains one or more game character images showing a game character and item images each showing an item, is displayed. An item type is determined by causing a player to select at least one item image displayed on the display screen. If the player's input is provided to the touch panel, a coordinate value, which indicates a position on the touch panel where the player's input is provided, is detected at predetermined time intervals. Further, a graphical shape of an input trajectory represented by a group of detected coordinate values is identified. A process detail for changing a characteristic parameter of the game character is changed in accordance with a combination of the item type and the graphical shape of the input trajectory.

### FIELD OF THE INVENTION

The present invention relates to a game system, and more particularly to a game system using a touch panel as an input device.

### BACKGROUND AND SUMMARY OF THE INVENTION

Conventionally, there have been proposed game apparatuses which can be operated using an input device other than a controller having a cross-key pad and buttons. For example, there is a conventional game system for playing a game using a sword-like controller to attack enemy characters in the game (see, for example, Japanese Laid-Open Patent Publication No. 2003-79943) In this game system, the position of the sword-like controller and the amount of variation in the position per unit of time are detected by a sensor, and a degree of damage caused to an enemy character by attack is determined in accordance with the speed or amplitude of swing of the sword-like controller. In such a conventional game system, the player is able to feel as if he/she is attacking the enemy characters in the game using a real sword.

In the above conventional game system, the degree of damage caused to an enemy character is determined in accordance with the speed or amplitude of swing of the sword-like controller, and the means of attacking the enemy characters is limited to a sword, lacking variation in attack. Such simple means of attacking makes the game itself monotonous, easily boring the player. Specifically, one input operation uniquely makes one type of attack action, and therefore the game easily bores the player. It is important in particular for a recent game to allow the player to designate, for example, a damage degree and an area affected by an attack so as to enable a variety of types of attack methods and realize a wide variety of attack variations, thereby allowing the player not to be bored with the game.

Therefore, a feature of the illustrative embodiments is to provide a game system which enables various game operations to provide a player with an opportunity to play a game in various manners.

The illustrative embodiments have the following features to attain the feature mentioned above. It should be noted that reference numerals and supplemental remarks in parentheses merely indicate correspondence with a preferred embodiment which will be described further below for the purpose of better understanding of the present invention, and do not restrict the scope of the present invention.

The illustrative embodiments are directed to a computer-readable storage medium having a game program stored therein, the game program causing a computer of a game apparatus (1), which includes a display screen (a first LCD 11) for displaying a game image and a touch panel (13) provided on the display screen, to implement the following steps. Specifically, the game program causes the game apparatus to implement: a game image display step (steps S41 and S45; hereinafter, only step numbers are shown); an item determination step (S46); a coordinate detection step (S61); a shape identification step (S62-S65); and a characteristic parameter change step (S69). The game image display step allows a game image, which contains one or more game character images showing a game character (an enemy character 31) and item images (item images 32a-32d) each showing an item, to be displayed on the display screen. The item determination step determines an item type by causing a player to select at least one item image displayed on the display screen. The coordinate detection step detects a coordinate value at predetermined time intervals, and the coordinate value indicates a position on the touch panel where a player's input is provided. The shape identification step identifies a graphical shape of an input trajectory represented by a coordinate value group (an input coordinate list 22a) detected by the coordinate detection step. The characteristic parameter change step changes the details of a process (an attack process) for changing a characteristic parameter (HP), which indicates a characteristic of the game character, in accordance with a combination of the item type determined by the item determination step and the graphical shape of the input trajectory identified by the shape identification step. Note that the item image is not limited to an image displayed in the form of an icon, and includes an image which indicates the name of the item by characters.

Note that the game program may further cause the computer to implement a change representation addition step (S73). The change representation addition step introduces a change to the game image in accordance with the combination after the graphical shape of the input trajectory is identified by the shape identification step.

Also, the shape identification step may identify the graphical shape of the input trajectory based on a unit of the coordinate value group detected by the coordinate detection step within the predetermined time period.

Also, if the graphical shape of the input trajectory identified by the shape identification step is a first shape (a shape specified by shape no. 1 shown in FIG. 6A), the characteristic parameter change step may change the characteristic parameter by a first amount of change. In this case, if the graphical shape of the input trajectory is a second shape (a shape specified by shape no. 11 shown in FIG. 6A), the characteristic parameter is changed by a second amount of change which is greater than the first amount of change. The second shape is more complicated than the first shape.

Also, the shape identification step may obtain an input direction of the input trajectory on the game character. In this case, the characteristic parameter change step changes a degree in change of the characteristic parameter in accordance with the input direction of the input trajectory.

Also, the game program may further cause the computer to implement a character selection step (S66). The character selection step selects a game character having a characteristic parameter to be changed, from among one or more game characters contained in the game image, based on relationships between a position of the input trajectory on the touch panel and positions of the one or more game characters. In this case, the characteristic parameter change step changes only the characteristic parameter of the game character selected by the character selection step.

Note that the illustrative embodiments also provides a game apparatus having a display screen for displaying a game image and a touch panel provided on the display screen. The game apparatus comprises a game image display control unit (S41, S45), an item determination unit (S46), a coordinate detection unit (S61), a shape identification unit (S62-S65), and a characteristic parameter change unit (S69). The game image display control unit allows a game image, which contains one or more game character images showing a game character (an enemy character 31) and item images (32a-32d) each showing an item, to be displayed on the display screen. The item determination unit determines an item type by causing a player to select at least one item image displayed on the display screen. The coordinate detection unit detects a coordinate value at predetermined time intervals, and the coordinate value indicates a position on the touch panel where the player's input is provided. The shape identification unit identifies a graphical shape of an input trajectory represented by a coordinate value group (an input coordinate list 22a) detected by the coordinate detection step. The characteristic parameter change unit changes a process detail for changing a characteristic parameter, which indicates a characteristic of the game character, in accordance with a combination of the item type determined by the item determination step and the graphical shape of the input trajectory identified by the shape identification step.

In the illustrative embodiments, the details of the process for changing the game character's characteristic parameter are determined based on a combination of two types of operations: a standardized selection operation of item selection by the user; and an arbitrary input operation of drawing the input trajectory. Accordingly, it is possible to expand the variation of operations by the player. That is, options for the player's operation are increased, whereby it is possible to provide a more strategic game. Accordingly, it is possible to offer the player various ways of playing the game, thereby making the game more enjoyable.

Also, in the case where the computer of the game apparatus further implements the change representation addition step, it is possible to provide the player with a visual effect which varies in accordance with the combination of two types of operations as described above, thereby making the game more enjoyable. That is, it is possible to present to the player a change of a game image in accordance with the graphical shape of the input trajectory and the item type. Moreover, the player is able to visually and intuitively know how the player him/herself is performing an input operation. Accordingly, the player is able to readily know whether the input operation is performed in a desired manner.

Also, in the case where the shape identification step identifies the graphical shape of the input trajectory based on a unit of the coordinate value group detected by the coordinate detection step within the predetermined time period, it is possible to achieve an effect as follows. The player is required to draw a desired input trajectory within the predetermined time period, and therefore the degree of difficulty of the game is increased, making it possible to provide a game which does not bore the player.

Further, in the case where the graphical shape of the input trajectory is the first shape, and the degree of change of the characteristic parameter is greater than the degree of change of the characteristic in the case where the graphical shape of the input trajectory is the second shape which is more complicated as compared to the first shape, it is possible to achieve an effect as follows. The player's skill of operating the touch panel is reflected in effects in the game, making it possible to provide a game with a more enhanced game play experience.

Also, in the case where the characteristic parameter change step changes the degree of change of the characteristic parameter in accordance with the input direction, the characteristic parameter is considerably changed by drawing an input trajectory on the game character from a first direction or slightly changed by drawing the input trajectory from a second direction, for example, whereby it is possible to expand the variation of the process for changing the characteristic parameter even if the graphical shape of the input trajectory is not changed.

Also, in the case where the computer of the game apparatus further implements the character selection step, not all game characters displayed on the display screen are considered to have a characteristic parameter to be changed, and a game character/game characters having a characteristic parameter to be changed is/are determined by an area defined by an input trajectory on the display screen. That is, the game character/game characters having a characteristic parameter to be changed is/are changed in accordance with an input position on the touch panel, and therefore more diverse game processes are provided in accordance with input operations, thereby making the game more enjoyable.

These and other features, aspects and advantages of the illustrative embodiments will become more apparent from the following detailed description of the present invention when taken in conjunction with the accompanying drawings.

### BRIEF DESCRIPTION OF THE DRAWINGS

FIG. 1 is an external view of a portable game apparatus according to an embodiment of the present invention;

FIG. 2 is a block diagram showing an internal structure of a game apparatus 1;

FIG. 3A is a diagram showing an exemplary game image displayed on a display screen of a first LCD 11;

FIG. 3B is a diagram showing another exemplary game image displayed on the display screen of the first LCD 11;

FIG. 4A is a diagram showing an exemplary game image displayed when a player is performing an attack operation;

FIG. 4B is a diagram showing another exemplary game image displayed after the attack operation is performed by the player;

FIGS. 5A and 5B each show an exemplary game image in the case where a wavy trajectory is inputted by an attack operation;

FIGS. 6A and 6B are tables respectively showing combinations of weapon types with input trajectory shapes and the effect of attack;

FIGS. 7A and 7B show exemplary game images after the attack operation having their respective input trajectories are drawn in different directions;

FIG. 8 is a diagram showing an example of an enemy character status table;

FIG. 9 is a diagram showing a memory map of a WRAM 22 included in the game apparatus 1;

FIG. 10 is a flowchart showing a flow of a game process implemented by the game apparatus 1;

FIG. 11 is a flowchart showing a detailed flow of a process of step S46 shown in FIG. 10;

FIGS. 12 and 13 are a flowchart showing the details of a flow of the process of step S47 shown in FIG. 10;

FIG. 14 is a flowchart showing a detailed flow of a process of step S61 shown in FIG. 10;

FIG. 15 is a diagram schematically showing how an input to a touch panel is performed;

FIG. 16 is a diagram showing an exemplary input coordinate list 22a;

FIG. 17A is a diagram used for explaining a process for simplifying the input coordinate list 22a;

FIG. 17B is another diagram used for explaining the process for simplifying the input coordinate list 22a;

FIG. 17C is still another diagram used for explaining the process for simplifying the input coordinate list 22a;

FIG. 18A is still another diagram used for explaining the process for simplifying the input coordinate list 22a;

FIG. 18B is still another diagram used for explaining the process for simplifying the input coordinate list 22a;

FIG. 19A is a diagram used for explaining a vector data list 22b;

FIG. 19B is another diagram used for explaining the vector data list 22b;

FIG. 20 is a diagram showing an example of input trajectory data 22c;

FIG. 21 is a diagram showing an example of a reference graphics database 22d;

FIG. 22 shows a variation of a portable game apparatus;

FIG. 23 shows another variation of the portable game apparatus; and

FIG. 24 shows still another variation of the portable game apparatus.

### DETAILED DESCRIPTION OF THE PREFERRED EMBODIMENTS

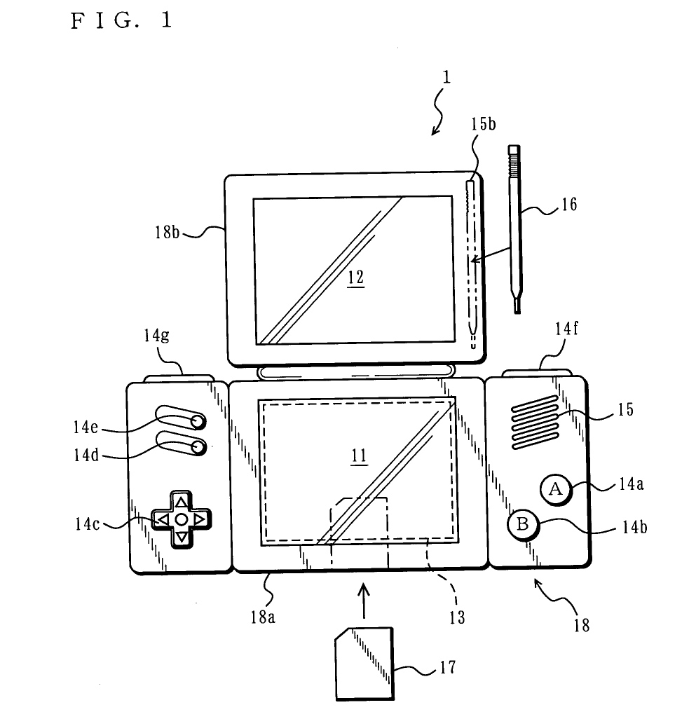

FIG. 1 is an external view of a portable game apparatus according to an embodiment of the present invention. In FIG. 1, a game apparatus 1 includes two liquid crystal displays (LCDs) 11 and 12 which are accommodated in a housing 18 so as to establish a predetermined positional relationship. Specifically, in order to accommodate the first and second LCDs 11 and 12 in a vertical direction, the housing 18 includes a lower housing 18a and an upper housing 18b. The upper housing 18b is supported on a portion of an upper side surface of the lower housing 18a so as to be freely flipped about that portion of the upper side surface of the lower housing 18a. The upper housing 18b has a planar shape slightly larger than the second LCD 12, and a top surface of the upper housing 18b has an opening to expose a display screen of the second LCD 12. The lower housing 18a has a planar shape wider than the upper housing 18b, and a top surface of the lower housing 18a has an opening substantially formed in its center so as to expose a display screen of the first LCD 11. The lower housing 18a has sound holes 15a for a loudspeaker 15 provided on one of two sides that are opposite of each other with respect to the first LCD 11, and also have elements of an operating switch section 14 provided on either one of the two sides.

Specifically, the operating switch section 14 includes operating switches 14a and 14b, a cross direction keypad 14c, a start switch 14d, and a select switch 14e. The operating switches 14a and 14b are provided on the top surface of the lower housing 18a so as to be located to the right of the first LCD 11. The cross direction key pad 14c, the start switch 14d, and the select switch 14e are provided on the top surface of the lower housing 18a so as to be located to the left of the first LCD 11. The operating switches 14a and 14b are used for inputting instructions to jump, punch, operate a weapon, and so on in an action game, or inputting instructions to obtain an item, select and determine a weapon or a command, and so on in a role playing game (RPG) such as a simulation RPG. The cross direction keypad 14c is used for indicating a moving direction on a game screen, e.g., a direction to move a player object (or a player character) which can be operated by the player, or a direction to move a cursor. If necessary, additional operating switches may be provided, or side switches 14f and 14g may be provided respectively on the right and left sides of the upper side surface of the lower housing 18a as shown in FIG. 1.

Furthermore, a touch panel 13 is provided on the first LCD 11 (as indicated by broken lines in FIG. 1). For example, the touch panel 13 may be of a resistive film type, an optical type (an infrared type), or a capacitive coupling type. When a stick 16 (or a finger) presses, strokes, or moves on the touch panel 13, the touch panel 13 detects a coordinate position of the stick 16 and outputs coordinate data.

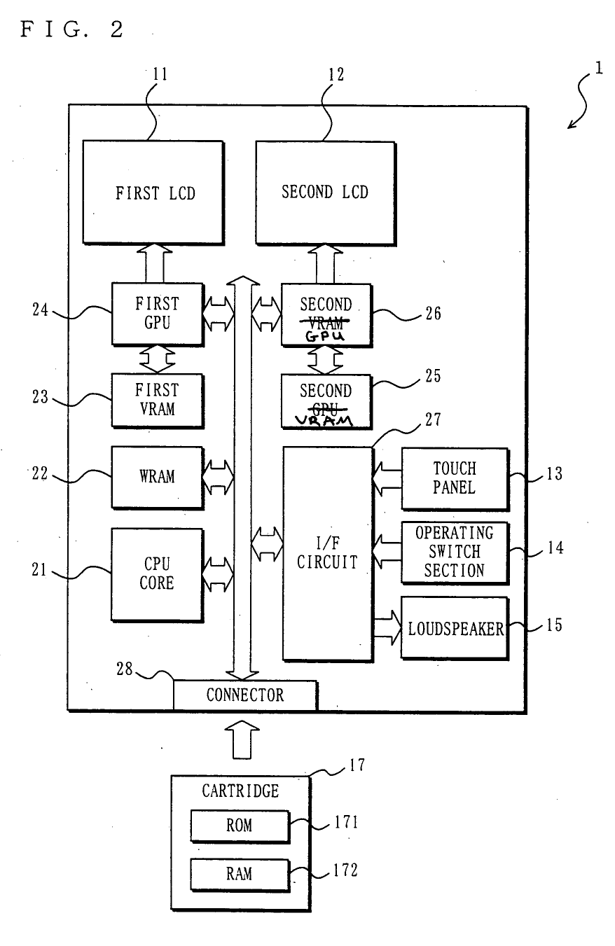

The upper housing 18b has a storage hole 15b (indicated by two-dot dashed lines in FIG. 1) formed in the vicinity of a side surface thereof in order to store the stick 16 for operating the touch panel 13 as necessary. The lower housing 18a has a cartridge insertion portion (indicated by one-dot dashed lines in FIG. 1) in a side surface thereof in order to freely load/unload a game cartridge 17. The cartridge 17 includes an information storage medium, e.g., a nonvolatile semiconductor memory such as a ROM or a flash memory, and has a game program recorded in the information storage medium. The cartridge insertion portion includes a connector (see FIG. 2) for electrically connecting the cartridge 17 to the game apparatus 1. The lower housing 18a (or the upper housing 18b) accommodates an electronic circuit board having mounted thereon various electronics including a CPU. Note that the information storage medium having a game program stored therein is not limited to the nonvolatile semiconductor memory, and may be an optical disk such as a CD-ROM or a DVD.

An internal structure of the game apparatus 1 is described now with reference to FIG. 2. FIG. 2 is a block diagram showing the internal structure of the game apparatus 1.

In FIG. 2, the electronic circuit board accommodated in the housing 18a has a CPU core 21 mounted thereon. The CPU core 21 is connected through a predetermined path to a connector 28 for connection to the cartridge 17, and also connected to an input and output interface (I/F) circuit 27, a first graphics processing unit (GPU) 24, a second GPU 26, and a working RAM (WRAM) 22.

The cartridge 17 is detachably connected to the connector 28. As described above, the cartridge 17 is a storage medium having a game program stored therein, and specifically includes a ROM 171 in which the game program is stored and a RAM 172 for storing backup data in a rewritable manner. The game program stored in the ROM 171 of the cartridge 17 is loaded to the WRAM 22, and then implemented by the CPU core 21. The WRAM 22 stores temporary data obtained by the CPU core 21 implementing the game program or data for generating images.

The I/F circuit 27 is connected to the touch panel 13, the operating switch section 14, and the loudspeaker 15. The loudspeaker 15 is located behind a portion of the lower housing 18a where the sound holes 15b are formed.

The first GPU 24 is connected to a first video RAM (VRAM) 23, and the second GPU 26 is connected to a second VRAM 25. The first GPU 24, responsive to an instruction from the CPU core 21, generates a first game image based on data for generating an image stored in the WRAM 22, and renders the generated image on the first VRAM 23. The second GPU 26, responsive to an instruction from the CPU core 21, generates a second game image based on data for generating an image stored in the WRAM 22, and renders the generated image on the second VRAM 25.

The first VRAM 23 is connected to the first LCD 11, and the second VRAM 25 is connected to the second LCD 12. The first GPU 24 outputs the first game image rendered on the first VRAM 23 to the first LCD 11. The first LCD 11 displays the first game image outputted from the first GPU 24. The second GPU 26 outputs the second game image rendered on the second VRAM 25 to the second LCD 12. The second LCD 12 displays the second game image outputted from the second GPU 26.

Described next is a game process implemented by the game apparatus 1 in accordance with the game program stored in the cartridge 17. Note that in the illustrative embodiments, a game image is displayed only on the first LCD 11 having the touch panel 13 provided on its display screen. Accordingly, the game apparatus of the illustrative embodiments may be configured so as not to include the second LCD 12. The game apparatus of the illustrative embodiments can be realized by a game apparatus, a PDA, or the like, which includes at least one display device and implements a game program of the illustrative embodiments.

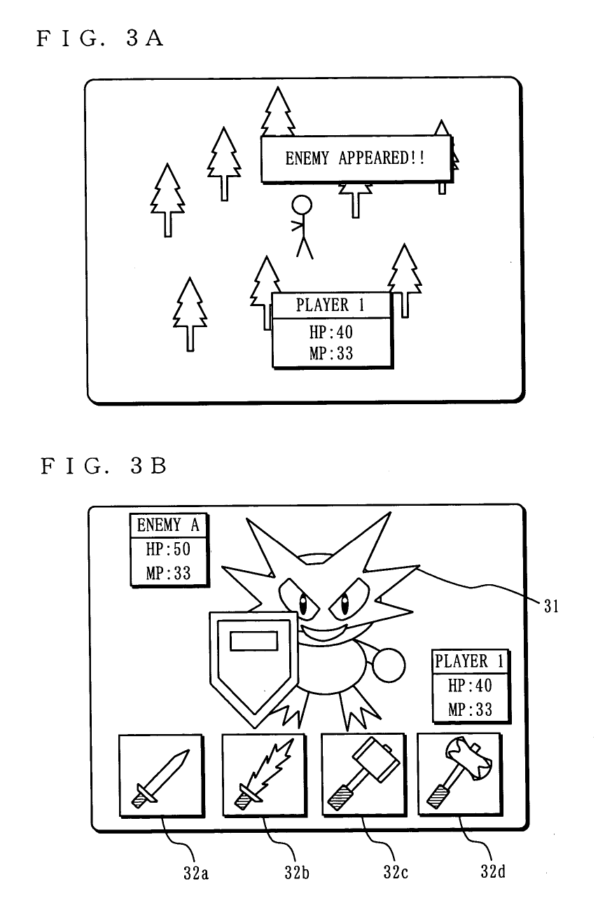

The game process implemented by the game apparatus 1 is described first along with an outline of a game implemented by the game apparatus 1. FIGS. 3A and 3B each show an exemplary game image displayed on the display screen of the first LCD 11. The illustrative embodiment is described by taking as an example a role-playing game as shown in FIGS. 3A and 3B, though games of any type can be implemented by the game apparatus of the present invention. Scenes in the role playing game are generally classified into two types: a movement scene (FIG. 3A) in which a player character operated by the player moves on a game map and a battle scene (FIG. 3B) in which the player character fights against enemy characters. In the movement scene, if a predetermined condition for the player character to encounter an enemy character is satisfied, the label “ENEMY APPEARED!!” is displayed as shown in FIG. 3A, and thereafter the game image is switched to the battle scene as shown in FIG. 3B. Note that in the case of the game apparatus including two display devices as shown in FIG. 1, the movement scene may be displayed on the second LCD 12, while the battle scene may be displayed on the first LCD 11.

In the battle scene as shown in FIG. 3B, a game image containing an enemy character 31 is displayed on the display screen of the first LCD 11. This game image contains item images 32a through 32d each showing an item. In FIG. 3B, the items are weapons, such as swords, an axe, etc., which are used by the player character for attacking the enemy character 31. Specifically, the item image 32a shows a regular sword, the item image 32b shows a thunder sword, the item image 32c shows a hammer, and the item image 32d shows an ax. Characteristic parameters of the player character and the enemy character are also displayed on the display screen. Note that each characteristic parameter indicates a value representing a characteristic of a game character appearing in the game. Specifically, the characteristic parameter is displayed on the first LCD 11 to indicate the player character's hit point (HP) or magic point (MP), or an enemy character's HP or MP. After the game image is switched to the battle scene, a battle progresses as the player character and the enemy characters attack each other.

When the player character's turn to attack comes during a battle, the player initially performs an item determination operation. The item determination operation is an operation for determining a weapon for use in attack. The item determination operation is performed by selecting any of the item images 32a through 32d displayed on the display screen. Specifically, the player touches with his/her finger a location where an item image showing a desired weapon is displayed, thereby selecting the item image. The player character uses the selected weapon to attack the enemy character 31. Note that the item determination operation may be performed for each time the player character's turn to attack comes, or may be performed only at the beginning of the battle scene. Moreover, it is not necessary to use the touch panel 13 to perform the item determination operation, and the item determination operation may be performed using the cross direction keypad 14c, for example.

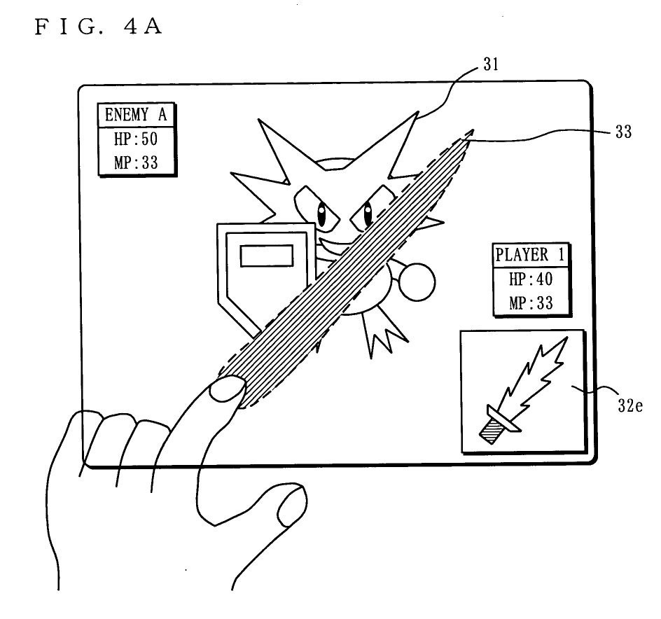

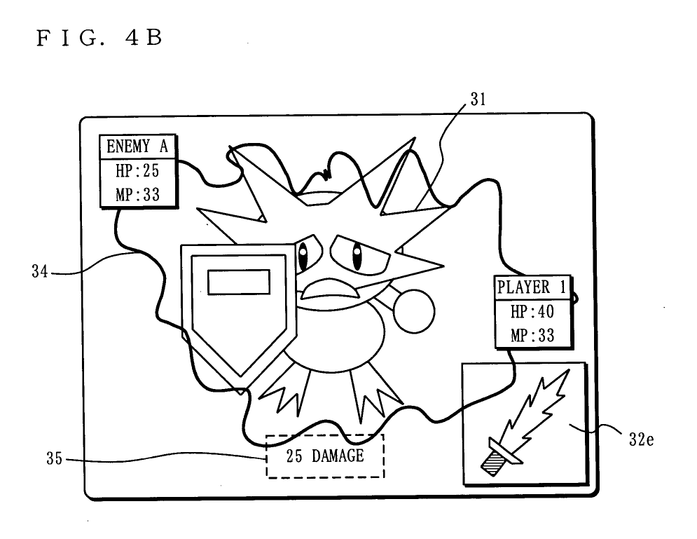

After the item determination operation, the player performs an attack operation using the touch panel 13. FIGS. 4A and 4B are diagrams used for explaining the attack operation. FIG. 4A shows an exemplary game image displayed when the player is performing the attack operation. Upon completion of the item determination operation, an item image 32e, which shows an item determined by the item determination operation, is displayed. Thereafter, the player performs the attack operation by moving his/her finger on the touch panel 13. In the attack operation, the player moves the finger so as to draw a predetermined trajectory (a reference graphic as described below). Such a trajectory indicates a position on the touch panel 13 where the player's input is provided, and is hereinafter referred to as an “input trajectory.” Note that the above-mentioned predetermined trajectory is predefined by the game apparatus 1. Here, the predetermined shape is a straight line running horizontally on the display screen, a straight line running vertically on the display screen, or a zigzag staggered line, for example. Accordingly, the player moves the finger on the touch panel 13 so as to draw an input trajectory of a predetermined shape. Note that in the illustrative embodiment, it is assumed that the attack operation is performed within a predetermined time period after detection of an input to the touch panel 13 (i.e., after the touch panel 13 is touched by the player's finger). That is, the game apparatus 1 accepts an input to the touch panel 13 only within the predetermined time period after the detection of the input to the touch panel 13.

When the attack operation is performed by the player, an input trajectory representation 33, which represents an input trajectory drawn by the attack operation, is displayed on the display screen. In FIG. 4A, the input trajectory representation 33 is displayed on the display screen as a line running from upper right to lower left. The input trajectory representation 33 is displayed at a position on the display screen which corresponds to a position on the touch panel 13 where the player's input is provided. That is, the input trajectory representation 33 is displayed as the player's finger moves on the touch panel 13. Note that the input trajectory representation 33 may be in such a display form as to indicate a portion actually touched by the player's finger (see FIG. 4) or may be in a linear display form obtained by connecting points at which input is detected by the touch panel 13. The input trajectory representation 33 allows the player to clearly and directly perceive the input trajectory drawn by his/her input operation. Accordingly, the player is able to know whether the input trajectory is drawn in a desired shape, i.e., whether a desired attack operation has been performed.

FIG. 4B shows an exemplary game image displayed after the attack operation is performed by the player. In the illustrative embodiment, an attack by the player is performed on an enemy character which is in contact with the input trajectory (the input trajectory representation 33). In the case where there is no enemy character which is in contact with the input trajectory, the player character is deemed to fail in attack. Accordingly, in order to designate an enemy character targeted for attack, the player is required to draw the input trajectory so as to pass through the location where the enemy character is displayed. In FIG. 4A, the enemy character 31 is in contact with the input trajectory, and therefore the player character is deemed to succeed in attack. If the player character is successful in attack, an effect representation 34 is displayed for representing the player character's attack against the enemy character 31. Further, a damage indication 35 is displayed to indicate a degree of damage caused to the enemy character 31 by the player character's attack. At this point, the game apparatus 1 performs a process (an attack process) for changing the characteristic parameter HP of the enemy character 31. In the example of FIG. 4B, the game apparatus 1 decreases the HP of the enemy character 31 by 25. As a result, the HP of the enemy character 31 (in FIG. 4B, indicated as enemy character A), which has been decreased by 25, is indicated in an indication on the upper left corner of the display screen which indicates the enemy character's characteristic parameters.

Note that in FIG. 4A, it is preferred that the enemy character 31 moves within a displayed area. This is because the movement of the enemy character 31 targeted for attack makes it difficult to draw the input trajectory on the enemy character 31, thereby making the game more challenging.

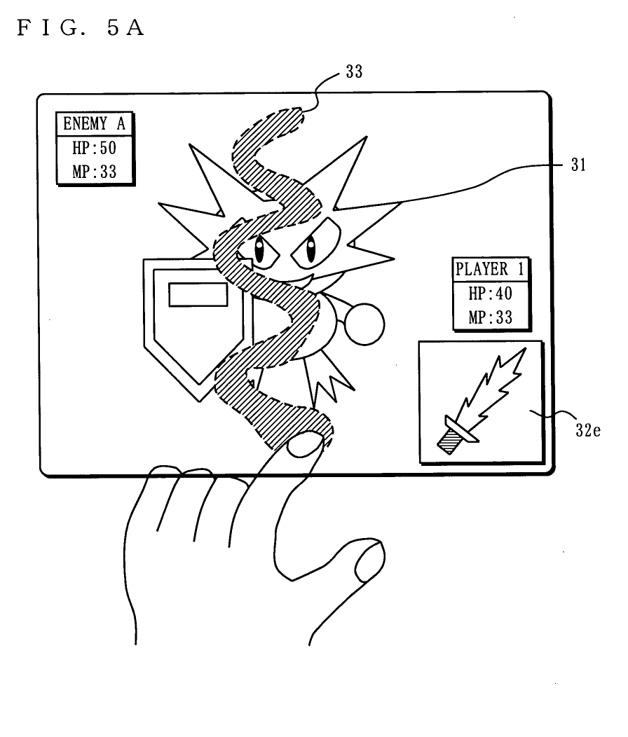

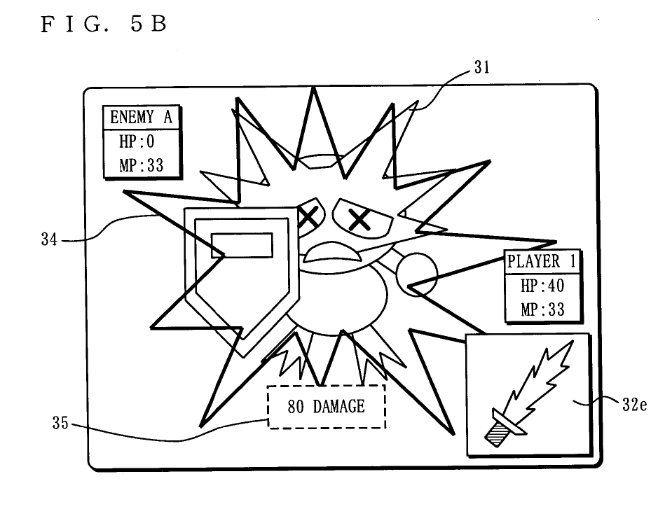

In the present embodiment, a degree of damage to be caused to an enemy character varies in accordance with a combination of the type of item (a weapon) determined by the item determination operation and the shape of the input trajectory. Note that the shape of the input trajectory as described herein refers to the shape of graphics drawn by the input trajectory. FIGS. 5A and 5B each show an exemplary game image in the case where a wavy trajectory is inputted by an attack operation. Note that in FIG. 5A, as the player character's weapon, the same thunder sword as that of FIG. 4A is selected. FIG.5A shows an exemplary game image displayed when the player is performing the attack operation. In FIG. 5A, the player is drawing an input trajectory in the shape of a sawtooth wave. A game image displayed after the player's attack operation is as shown in FIG. 5B. In FIG. 5B, a degree of damage caused to the enemy character 31 is greater than the degree of damage shown in FIG. 4B.

As is apparent from FIGS. 4A through 5B, the shape of the input trajectory and the effect of attack are preferably in a relationship such that the effect of attack becomes greater as the shape of the input trajectory becomes more complicated. Specifically, comparing the shape of the input trajectory shown in FIG. 4A and the shape of the input trajectory shown in FIG. 5A, it is clear that the shape shown in FIG. 5A is more complicated. As described above, in the illustrative embodiment, any input to the touch panel 13 needs to be carried out within the above-described predetermined time period. Accordingly, a complicated shape as shown in FIG. 5A is more difficult to input than a simple shape as shown in FIG. 4A. Therefore, the player's operational skill can be reflected in the effect of attack by increasing the effect of attack (i.e., damage to an enemy character) with the complexity of input. Thus, it is possible to enhance the nature of the game, thereby making the game more challenging.

Also, in the illustrative embodiment, the details of the effect representation 34 varies in accordance with a combination of the type of an item (a weapon) determined by the item determination operation with the shape of the input trajectory. Specifically, the effect representation is different between the example shown in FIG. 4B and the example shown in FIG. 5B. Thus, the player is able to know whether a desired input operation has been carried out, and a variety of the types of effect representation can visually amuse the player.

Thus, as is apparent from FIGS. 4A through 5B, in the illustrative embodiment, the details of a process (an attack method) for attacking an enemy character vary in accordance with a combination of the type of a weapon and the shape of the input trajectory. Accordingly, damage to be caused to the enemy character also varies in accordance with a combination of the type of a weapon and the shape of the input trajectory. For example, even if the same weapon is used, damage to be caused to the enemy character varies in accordance with the shape of the input trajectory. Also, if the player draws the same input trajectory, the damage to be caused to the enemy character varies in accordance with the player character's weapon. Thus, it is possible to expand the variation in attack during battle. Examples of correspondence between each combination of weapon types with input trajectory shapes and the effect of attack corresponding to the combination are described in detail below.

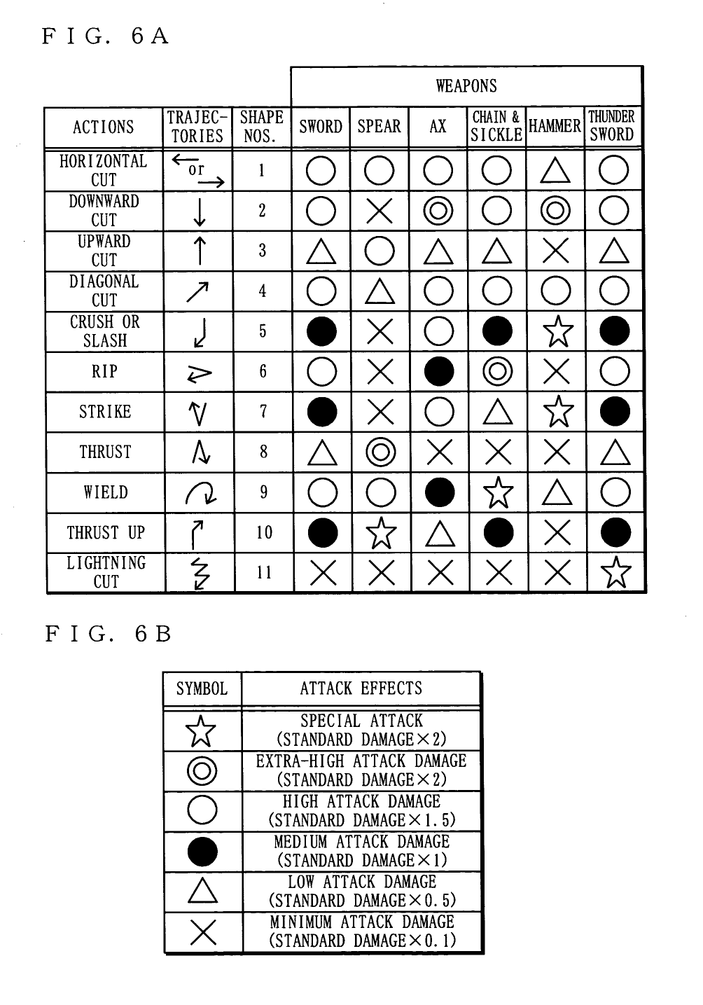

FIGS. 6A and 6B are tables respectively showing combinations of weapon types with input trajectory shapes and the effect of the attack. In FIG. 6A, “WEAPONS (sword, spear, ax, chain & sickle, hammer, and thunder sword)” indicates the types of weapons selected by the player in the item determination operation. “TRAJECTORIES” indicates the shapes of trajectories inputted by the player in the attack operation. Note that “ACTIONS” shown in FIG. 6A indicates names corresponding to the shapes of the input trajectories (i.e., input operations by the player). Here, each shape of the input trajectories is added with a name of attack method, such as “HORIZONTAL CUT” or “DOWNWARD CUT”. “SHAPE NOS.” indicates numbers added for identifying the shapes of the input trajectories. The game apparatus 1 refers to a previously prepared table as shown in FIG. 6A during a game process of a battle scene, and determines a degree of damage caused by attack. Note that the table as shown in FIG. 6A is referred to below as an “item table.”

In the item table shown in FIG. 6A, symbols are associated with combinations of weapon types and input trajectory shapes. Each symbol represents the effect of attack carried out when a combination associated therewith is selected by the player (see FIG. 6B). Note that attack effects shown in FIG. 6B represent degrees of damage caused to an enemy character by attack. For example, if the “SWORD” is selected by the item determination operation and “HORIZONTAL CUT” is input by the attack operation, the attack effect is “HIGH ATTACK DAMAGE”. In this case, the degree of damage caused by attack is 1.5 times the standard damage. Specifically, the degree of damage caused to the enemy character is calculated by multiplying the degree of standard damage by a factor determined for each type of attack effects. Note that the degree of standard damage is predetermined for each weapon. For example, if the “SWORD” for which the degree of standard damage is set at 50 is selected, and the attack effect is “HIGH ATTACK DAMAGE,” the degree of damage caused to the enemy character is calculated as follows: 50×1.5=75.

Note that in FIG. 6B, the attack effect of “SPECIAL ATTACK” is set. Here, the term “special attack” refers to an attack method capable of causing more damage than a normal attack depending on the type of the enemy character. Specifically, the degree of damage caused by the special attack varies depending on an attribute of the enemy character. The attribute of the enemy character is a parameter indicating a degree of damage caused by the special attack. For example, the attribute of the enemy character could indicate that the enemy character has low resistance to an attack by thunder or low resistance to a striking attack by hammer. Note that in other embodiments, the special attack may be an attack method for causing more damage than normal damage caused by an attack by weapon. Examples of such attacks include an attack by magic, an attack of poisoning the enemy character, etc.

In FIG. 6A, the attack effect of “MINIMUM ATTACK DAMAGE” is associated with, for example, a combination of the weapon “SPEAR” and the action “DOWNWARD CUT.” This means that an input operation of “DOWNWARD CUT” is not suitable for a case where the spear is selected as a weapon. Also, the attack effect of “EXTRA-HIGH ATTACK DAMAGE” is associated with a combination of the weapon “SPEAR” and the action “THRUST”. This means that an input operation of “THRUST” is very suitable for a case where the spear is selected as a weapon. That is, even if the same “SPEAR” is selected as a weapon, the attack effect varies depending on the shape of the input trajectory (i.e., the type of input operation). Also, it is understood from FIG. 6A that in the case where the player performs an input operation of “LIGHTNING CUT” when the weapon is the “THUNDER SWORD”, it is possible to achieve the attack effect of the special attack. However, in the case where the player performs an input operation of “LIGHTNING CUT” when another weapon is selected, the attack effect is “MINIMUM ATTACK DAMAGE”. That is, even if the player performs the same input operation, the attack effect varies depending on the type of selected weapon. As such, the item table may be set so as to establish suitability between weapon types and input trajectory shapes. This increases a strategic characteristic in a game operation in a battle scene, thereby making the game more enjoyable.

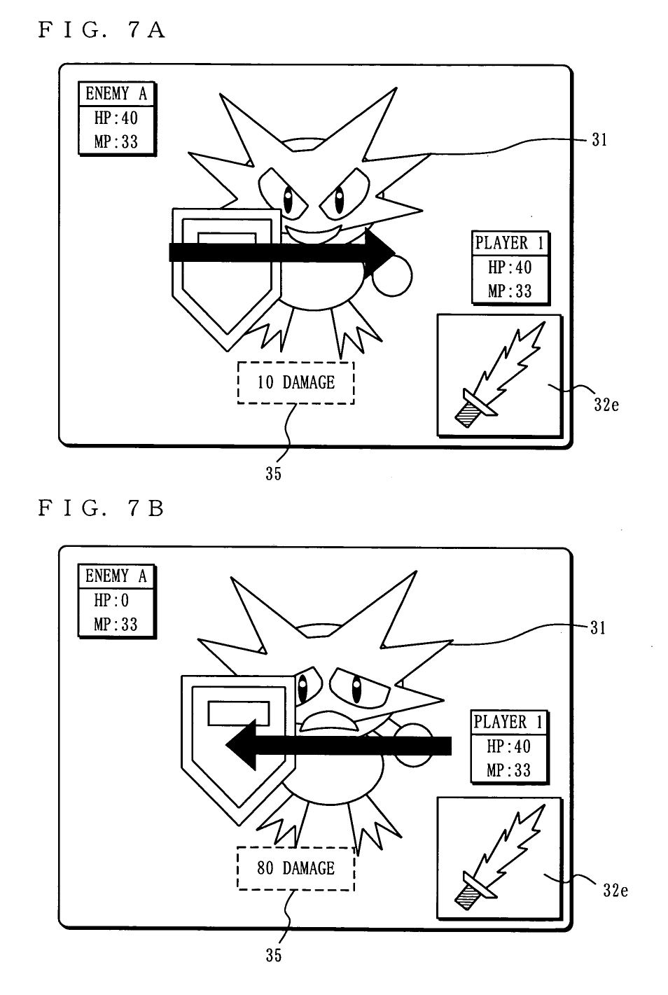

Further, in the illustrative embodiment, the damage to be caused to the enemy character also varies depending on a direction in which the input trajectory is inputted (an input direction). FIGS. 7A and 7B show exemplary game images after the attack operation having their respective input trajectories are drawn in different directions. Arrows shown in FIGS. 7A and 7B indicate the input trajectories and input directions thereof. Specifically, FIG. 7A is a game image displayed when a straight line is inputted so as to extend horizontally from left to right on the display screen, and FIG. 7B is a game image displayed when a straight line is inputted so as to extend horizontally from right to left on the display screen. Note that for the sake of simplification, the effect representation is not shown in FIGS. 7A and 7B.

Here, the enemy character 31 shown in FIGS. 7A and 7B holds a shield on the left side of the display screen, and is assumed to have low resistance to an attack from the right side of the display screen. Accordingly, as shown in FIGS. 7A and 7B, even if the input trajectory is a straight line extending horizontally on the display screen, damage caused to the enemy character in the case where the straight line is inputted from left to right (FIG. 7A) is smaller than damage caused in the case where the straight line is inputted from right to left (FIG. 7B). As such, in the illustrative embodiment, even if the same weapon is selected and the input trajectory is drawn in the same shape, the damage to the enemy character varies depending on the input direction of the input trajectory. This expands the variation in game operation in a battle scene, while increasing the strategic characteristic of the game operation, thereby making the game more enjoyable. Note that an input direction in which damage by attack is increased compared to other input directions is referred to below as a “vulnerable direction.”

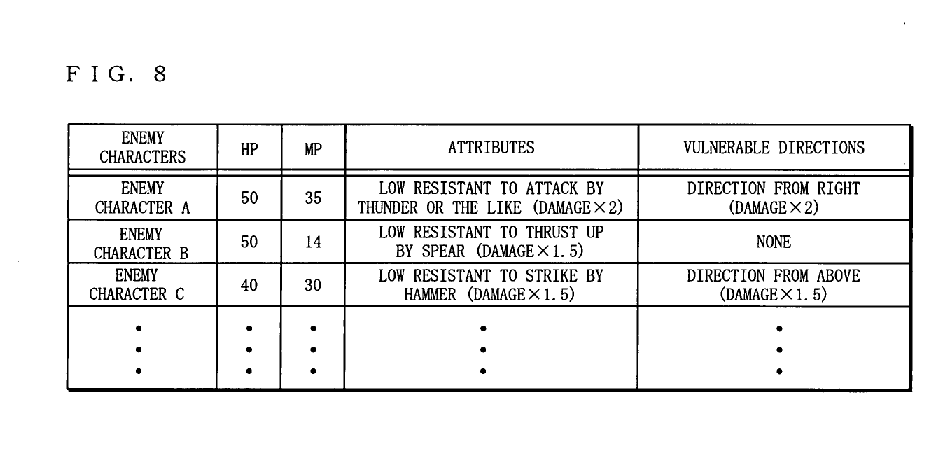

Note that in the illustrative embodiment, the character attribute varies depending on the type of the enemy character. The vulnerable direction also varies depending on the type of the enemy character. The character attribute and the vulnerable direction are predetermined by the apparatus 1 for each enemy character type. FIG. 8 is a diagram showing an example of an enemy character status table. The enemy character status table is a table in which HP, MP, a character attribute, and a vulnerable direction are associated with each other for each enemy character type. As described above, the character attribute is a parameter indicating a degree of damage caused by the special attack. Specifically, the attribute field of the enemy character status table contains the type of special attack effective (or ineffective) against the enemy character, and a factor for changing the degree of damage when a special attack is carried out. For example, FIG. 8 shows that enemy character A has an attribute of low resistance to an attack by thunder or the like (i.e., the attack by thunder or the like is effective), and damage caused by a special attack by thunder or the like (e.g., an attack carried out when an input operation of lightning cut with the thunder sword is performed) is high. Enemy character A of FIG. 8 attacked with the attack by thunder or the like receives twice the damage caused by the same attack to other enemy characters. Note in other embodiments, the effect of special attack is not limited to the effect of increasing damage more than normal. For example, an enemy character attacked with the special attack may be poisoned or may be stopped from attacking for a few turns.

As mentioned above, the vulnerable direction is an input direction in which damage by attack is increased compared to other input directions. The vulnerable direction field of the enemy character status table contains a direction indicating the vulnerable direction, and a factor for changing the degree of damage when an attack from the vulnerable direction is carried out. For example, FIG. 8 shows that the vulnerable direction of enemy character C is a direction from above, and damage is high in the case where the input direction of the input trajectory is the direction from above. Here, damage caused to enemy character C when the input direction of the input trajectory is the direction from above is 1.5 times the damage caused when the input direction of the input trajectory is another direction.

Note that in other embodiments, the enemy character status table may contain information indicating a vulnerable spot. The term “vulnerable spot” refers to a location where the degree of damage is increased when the input trajectory passes through the referenced location. Specifically, if the input trajectory passes through the vulnerable spot of an enemy character, the degree of damage is increased compared to a case where the input trajectory does not pass through the referenced location. This expands the variation in attack, thereby allowing the player to carry out a wider variety of game operations.

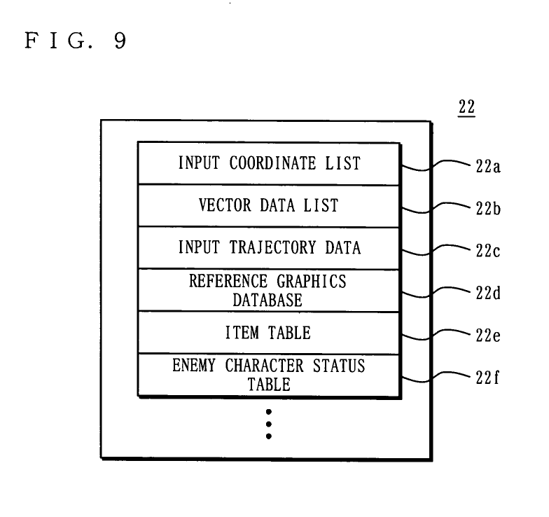

Next, the details of the game process implemented by the game apparatus 1 are described. Described first is data that is stored into the WRAM 22 during the game process. FIG. 9 is a diagram showing a memory map of the WRAM 22 included in the game apparatus 1. For example, an input coordinate list 22a, a vector data list 22b, input trajectory data 22c, a reference graphics database 22d, an item table 22e, enemy character status table 22f, etc, are stored into the WRAM 22 during the game process. In addition to the above, a game program and game image data read from the cartridge 17 are stored in the WRAM 22.

The input coordinate list 22a contains a set of coordinate values (a coordinate value group) (see FIG. 16 which will be described later). Each coordinate value indicates a position on the touch panel where the player's input is provided. In the illustrative embodiment, positions on the touch panel where the player's input is provided are detected at prescribed time intervals. The detected positions are represented by coordinate values. Coordinate values, which are detected within a predetermined time period after the player begins input, are stored as a list in the WRAM 22.

The vector data list 22b contains a set of vector data (a vector data group) (see FIG. 19A which will be described later). Each piece of vector data in the set indicates a direction and a distance between adjacent coordinate values contained in the input coordinate list 22a. The vector data list 22b is obtained based on the input coordinate list 22a.

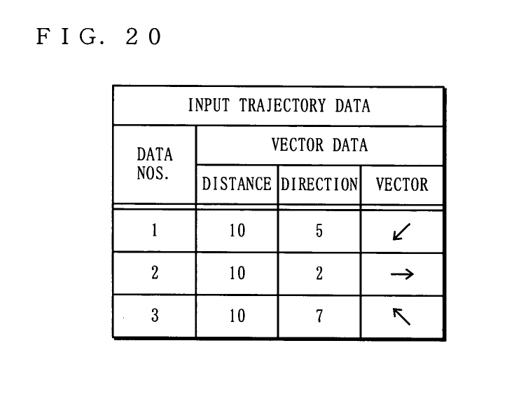

The input trajectory data 22c represents, as a piece of vector data, a plurality of sequential pieces of vector data indicating the same direction and contained in the vector data list 22b (see FIG. 20 which will be described later). Accordingly, the input trajectory data 22c is obtained based on the vector data list 22b. The vector data list 22b and the input trajectory data 22c are used for specifying the shape of the input trajectory indicated by the coordinate value group contained in the input coordinate list 22a.

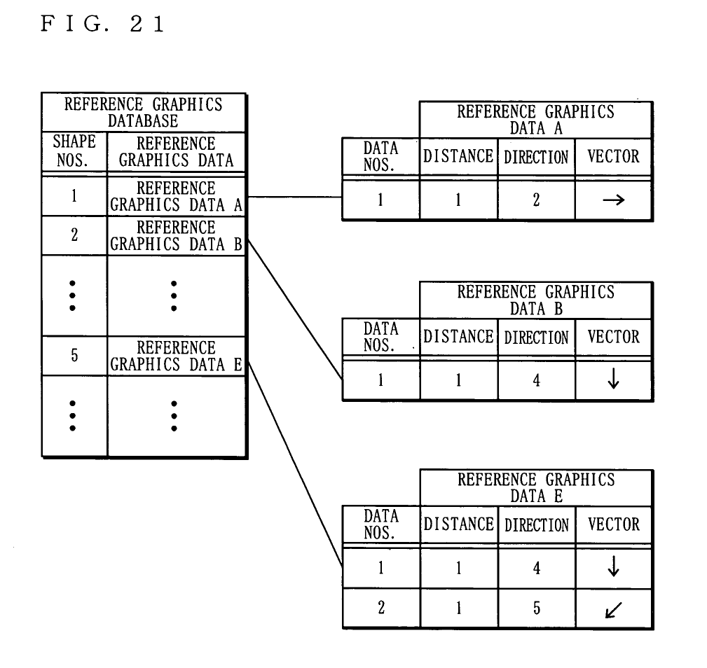

The reference graphics database 22d contains a plurality of pieces of reference graphics data (see FIG. 21 which will be described later). Each piece of the reference graphics data represents a reference graphic designed so as to be associated with a style of attack by the player character, and the number of the plurality of pieces of the reference graphics data corresponds to the number of styles of attack by the player character. Note that the reference graphics database 22d is typically stored in the cartridge 17 together with the game program, and read from the cartridge 17 onto the WRAM 22 at the beginning of the game process. In the illustrative embodiment, similar to the vector data list 22b and the input trajectory data 22c, the reference graphics data contains one or more pieces of vector data.

The item table 22e is a table in which a combination of a weapon type and an input trajectory shape is associated with an attack effect achieved when an attack operation corresponding to the combination is carried out. The item table 22e is, for example, a table indicating correspondences as shown in FIG. 6A. Note that similar to the reference graphics database 22d, the item table 22e is typically stored in the cartridge 17 together with the game program, and read from the cartridge 17 onto the WRAM 22 at the beginning of the game process.

The enemy character status table 22f indicates the status of the enemy character. Specifically, the enemy character status table 22f is a table in which HP, MP, a character attribute, and variation of damage in accordance with an input direction of the input trajectory are associated with each other for each enemy character type (see FIG. 8). Note that in addition to the enemy character status table 22f, the WRAM 22 has stored therein data indicating the status of the player character. In addition to the data shown in FIG. 9, the WRAM 22 also has stored there in various types of data for use in the game process.

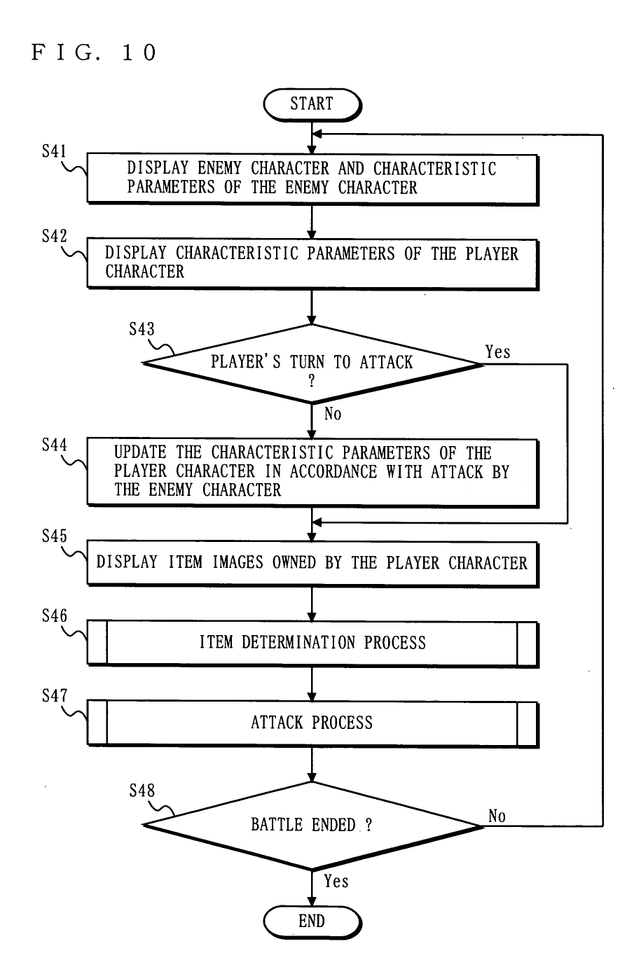

Next, a flow of the game process implemented by the game apparatus 1 is described with reference to FIGS. 10 through 14. FIG. 10 is a flowchart showing a flow of the game process implemented by the game apparatus 1. When the game apparatus 1 is turned on, the CPU core 21 of the game apparatus 1 implements a startup program stored in a boot ROM (not shown) to initialize units in the game apparatus 1, e.g., the WRAM 22. Then, a game program stored in the cartridge 17 is read onto the WRAM 22, and implementation of the game program is started. Consequently, a game image is generated in the first GPU 24, and then displayed on the first LCD 11, thereby starting a game. The game process shown in the flowchart of FIG. 10 is carried out after the game image is switched to a battle scene. Accordingly, the game process shown in the flowchart of FIG. 10 is started after a battle between the player character and the enemy characters is started. Note that the descriptions of the game process are omitted herein with respect to situations other than the battle scene which are not directly related to the present invention.

Referring to FIG. 10, in step S41, an enemy character, and the enemy character's characteristic parameters are displayed on the display screen of the first LCD 11 (see FIG. 3B). As the enemy character's characteristic parameters, HPs and MPs are displayed. In the following step S42, the player character's characteristic parameters are displayed on the display screen of the first LCD 11 (see FIG. 3B). As in the case of the enemy character's characteristic parameters, as the player character's characteristic parameters, HPs and MPs are displayed. In the following step S43, it is determined whether it is the player character's turn to attack. Note that a turn to attack is determined in accordance with a predetermined rule. Although this rule stipulates that the player character's turn to attack alternates with the enemy character's turn to attack, any rule can be adopted.

If it is determined in step S43 not to be the player character's turn to attack, the procedure proceeds to step S44 where the enemy character attacks the player character. Specifically, when the player character is attacked by the enemy character, values of characteristic parameters (i.e., HP and MP) of the player character are changed in accordance with the enemy character's attack. Accordingly, the values of the characteristic parameters of the player character stored in the WRAM 22 are updated. After the process of step S44, the procedure proceeds to step S45.

Referring back to step S43, if it is determined to be the player character's turn to attack, the player character attacks the enemy character in accordance with the processes of steps S45 through S47. In step S45, item images showing items (weapons) owned by the player character are displayed on the display screen of the first LCD 11 (see FIG. 3B). Note that the items owned by the player character and the item images are assumed to be stored in the WRAM 22. The CPU core 21 reads the item images from the WRAM 22, and causes the first LCD 11 to display the item images thereon. At this point, a table, which shows correspondences between each item image and the location of the item image on the display screen, is generated in the WRAM 22.

Next, in step S46, an item determination process is carried out. The item determination process is a process for determining an item used for the player character to attack the enemy character. The item used for the attack is determined by the player carrying out the item determination operation during the item determination process. The item determination process is described in detail below.

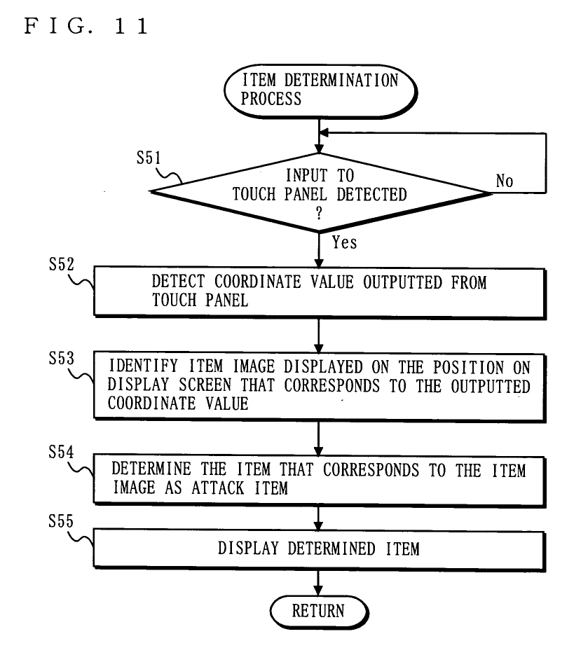

FIG. 11 is a flowchart showing a detailed flow of the process of step S46 shown in FIG. 10. Firstly, in step S51, it is determined whether any input to the touch panel 13 has been detected. If the player has operated on the touch panel 13 (i.e., the player's finger has touched the touch panel 13), an input to the touch panel 13 is detected and the procedure proceeds to step S52. On the other hand, if the player has not operated the touch panel 13, no input to the touch panel 13 is detected and the procedure returns to step S51. That is, the process of step S51 is repeatedly performed until the player operates the touch panel 13.

Next, in step S52, the CPU core 21 detects a coordinate value outputted from the touch panel 13. In the following step S53, an item image displayed on the position on the display screen that corresponds to the outputted coordinate value is identified. The identification of the item image is carried out with reference to the table generated in step S45. In the following step S54, the item indicated by the item image identified in step S53 is determined as an attack item (i.e., the item used for the player character to attack the enemy character). Then, in step S55, the determined item is displayed in the form of an icon. After step S55, the item determination process shown in FIG. 11 is terminated.

Referring back to FIG. 10, in step S47 following step S46, an attack process for the player character to attack the enemy character is performed. The attack process is a process for determining an enemy character targeted for attack by the player character, and the degree of damage caused to the enemy character. The player carries out the attack operation for the attack process. The attack process is described in detail below.

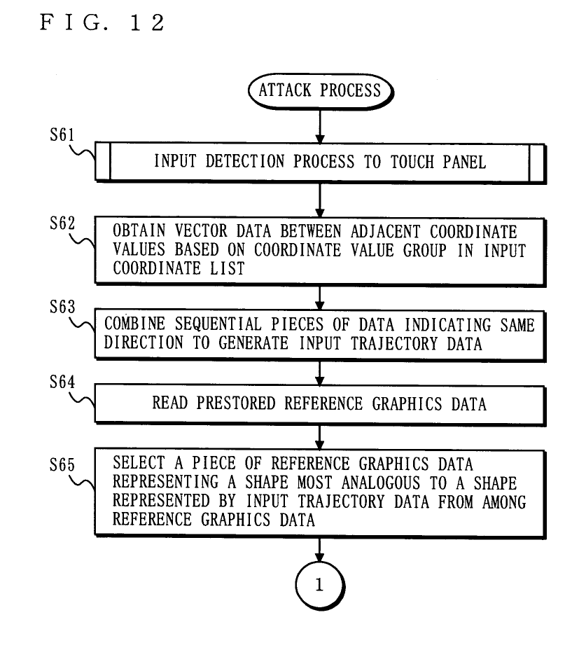

FIGS. 12 and 13 are a flowchart showing the details of a flow of the process of step S47 shown in FIG. 10. In the attack process, firstly, in step S61, an input detection process to the touch panel 13 is carried out. The input detection process to the touch panel 13 is a process for detecting the player's input to the touch panel 13 and generating the input coordinate list 22a. The input detection process to the touch panel 13 is described below.

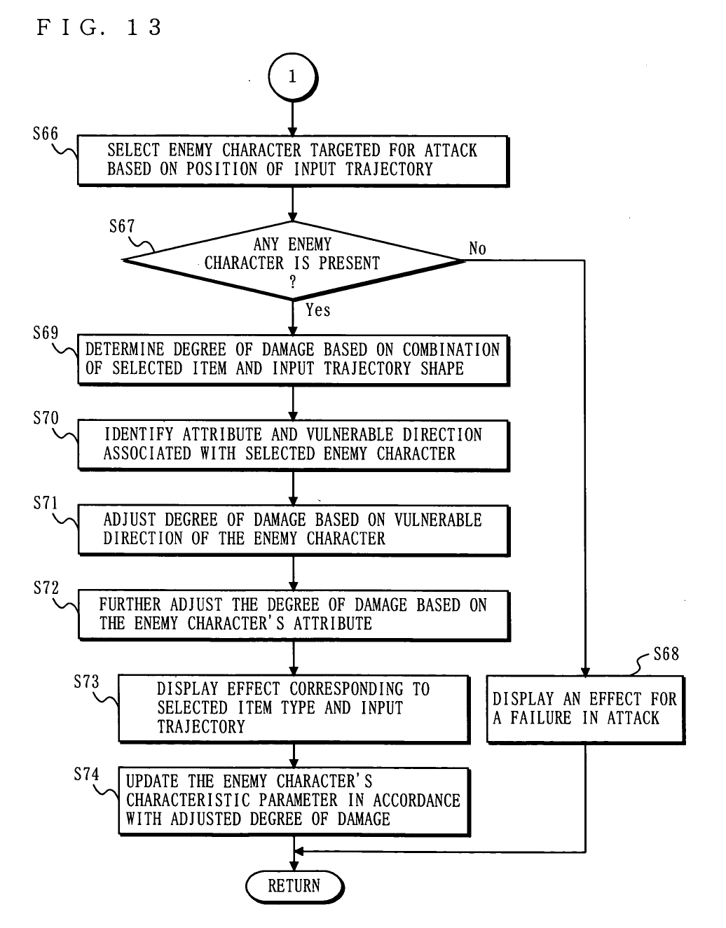

FIG. 14 is a flowchart showing a detailed flow of the process of step S61 shown in FIG. 12. Firstly, in step S81, the input coordinate list 22a stored in the WRAM 22 is initialized. Specifically, a memory region for storing a predetermined number of coordinate values is reserved within the WRAM 22. At this point, a coordinate value, which indicates a position where the player's input is provided, is not written in the input coordinate list 22a. In the following step S82, it is determined whether any input to the touch panel 13 has been detected. The process of step S82 is similar to the process of step S51 shown in FIG. 11. That is, the process of step S82 is repeatedly performed until the player operates the touch panel 13. If the player has operated on the touch panel 13, the procedure proceeds to step S83.

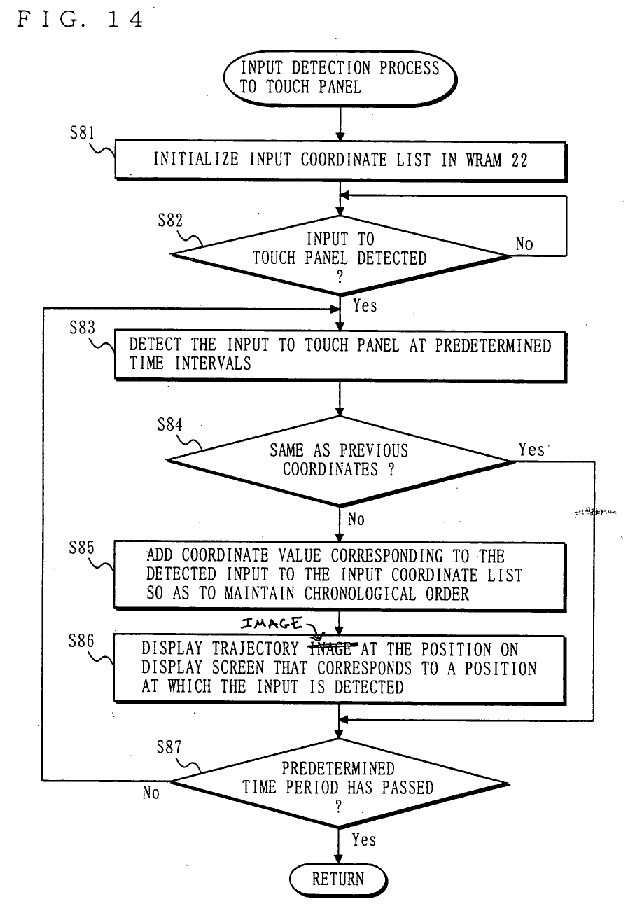

Processes of steps S83 through S87 are performed for detecting an input position on the touch panel 13. Through the processes of steps S83 through S87, the input coordinate list 22a is generated. The outline of the processes of steps S83 through S87 is described below with reference to FIGS. 15 and 16.

FIG. 15 is a diagram schematically showing how an input to a touch panel is performed. In FIG. 15, the player is assumed to have performed an input operation so as to draw a triangular input trajectory, as indicated by broken lines. In response to the input operation, the game apparatus 1 detects a position on the touch panel where the player's input is provided, at prescribed time intervals. Circles shown in FIG. 15 indicate positions (detection points) at which the player's input to the touch panel 13 has been detected.

In FIG. 15, a detection point p1 is detected before subsequent detection points p2, p3, . . . are sequentially detected. Note that in FIG. 15, the y-axis indicates the vertical axis (a normal direction thereof is directed downward to the bottom of FIG. 15), the x-axis indicates the horizontal axis (a normal direction thereof is directed to the right of FIG. 15), and the top left corner of the touch panel 13 is at the origin. There are n detection points (where n is an arbitrary integer). A coordinate value of the detection point p1 is (80,40), a coordinate value of the detection point p2 is (77,42), and a coordinate value of the detection point p3 is (75,45).

FIG. 16 shows an exemplary input coordinate list 22a generated when the player's input is provided as shown in FIG. 15. As shown in FIG. 16, the input coordinate list 22a contains detected coordinate values in the order of detection. Specifically, the coordinate value (80,40) at the detection point p1 is listed first, the coordinate value (77,42) at the detection point p2 is listed second, and the coordinate value (75,45) at the detection point p3 is listed third. In this manner, the coordinate values at the detection points are written into the input coordinate list 22a. Note that the exemplary input coordinate list shown in FIG. 16 contains n coordinate values corresponding to the number of detection points.

Detection of the player's input to the touch panel 13 is performed until a predetermined time period passes after an input to the touch panel 13 is detected in step S82. Generation of the input coordinate list 22a is terminated after the passage of the predetermined time period. In FIG. 15, the player's input to the touch panel 13 is not detected after detection of an n'th detection point pn. After that, if the predetermined time period passes, generation of the input coordinate list 22a is terminated. Consequently, the input coordinate list 22a having n coordinate values contained therein is generated. The thus-generated input coordinate list 22a represents an input trajectory inputted by the player within the predetermined time period. That is, in the present embodiment, an input trajectory represented by a coordinate value group detected within the predetermined time period is considered as one unit, thereby determining the shape of the input trajectory. The detailed descriptions of the processes of steps S83-S87 are given below.

Referring back to FIG. 14, in step S83, the player's input to the touch panel 13 is detected. Specifically, coordinate values, which indicate positions on the touch panel 13 where the player's input is provided, are sequentially transmitted from the touch panel 13 to the CPU core 21. The detection process in step S83 is carried out at predetermined time intervals. In the following step S84, it is determined whether the latest coordinate value detected in the last step S83 is the same as a coordinate value detected in the previous step S83 (i.e., the one before the last step S83). If these two values are determined to be the same, the processes of steps S85 and S86 are skipped because they are not required to be performed, and the procedure proceeds to step S87.

Referring back to step S84, if it is determined that the latest coordinate value detected in the last step S83 is not the same as the previous coordinate value, the procedure proceeds to step S85 where the latest coordinate value detected in the last step S83 is added to the input coordinate list 22a so as to maintain chronological order. That is, the latest coordinate value detected in the last step S83 is stored into the input coordinate list 22a so as to follow the previous coordinate value in the order they are detected (see FIG. 16).

Following step S85, in step S86, the input trajectory representation 33 (FIG. 4A) is displayed at a position on the display screen that corresponds to a location indicated by the latest coordinate value detected in the last step S83. Specifically, a line extending between a position indicated by the latest coordinate value detected in the last step S83 and the previous coordinate value detected in the previous step S83 is displayed on the first LCD 11. After the process of step S86, the procedure proceeds to step S87.

In step S87, it is determined whether a predetermined time period has passed after the player's input to the touch panel 13 was detected in step S82. Note that the predetermined time period is previously set by the game program or the game apparatus 1. If it is not determined in step S87 that the predetermined time period has passed, the procedure returns to step S83. Accordingly, the processes of steps S83 through S87 are repeatedly performed until the predetermined time period passes. On the other hand, if it is determined in step S87 that the predetermined time period has passed, the CPU core 21 terminates the input detection process to the touch panel shown in FIG. 14.

Referring back to FIG. 12, following step S61, in steps S62 through S65, the shape of the input trajectory represented by the input coordinate list 22a generated in step S61 is identified. The outline of a process for identifying the input trajectory is described below.

Among processes in steps S62 through S65, processes in steps S62 and S63 are performed for simplifying information contained in the input coordinate list 22a generated in step S61. Since the information contained in the input coordinate list 22a is a set of coordinate values, if the information is used as it is, it is difficult to identify the shape of the input trajectory. The processes of steps S62 and S63 are intended to facilitate easy identification of the shape of the input trajectory by processing the information contained in the input coordinate list 22a. The outline of the processes of steps S62 and S63 is now described.

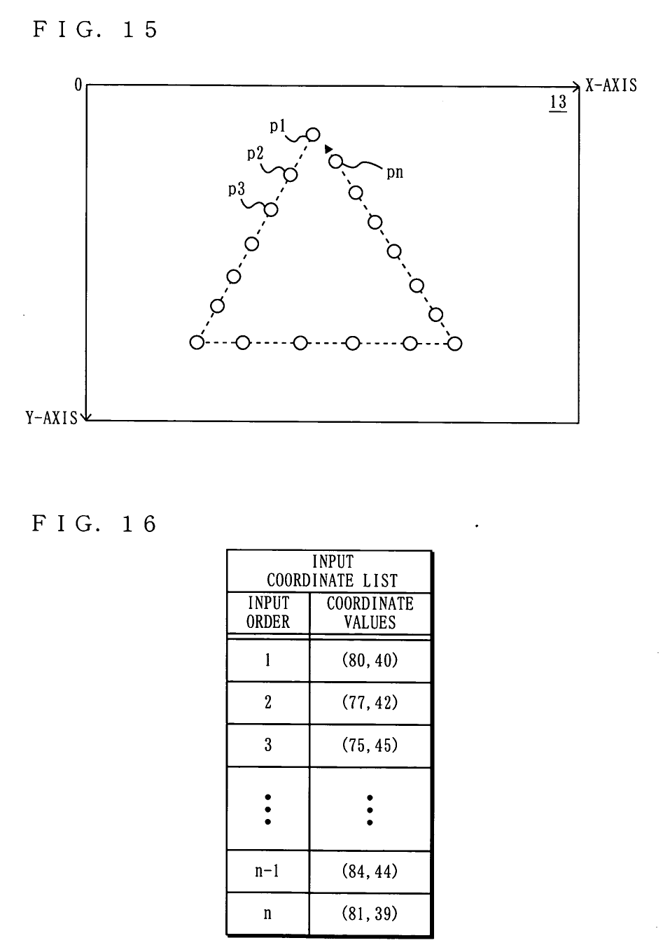

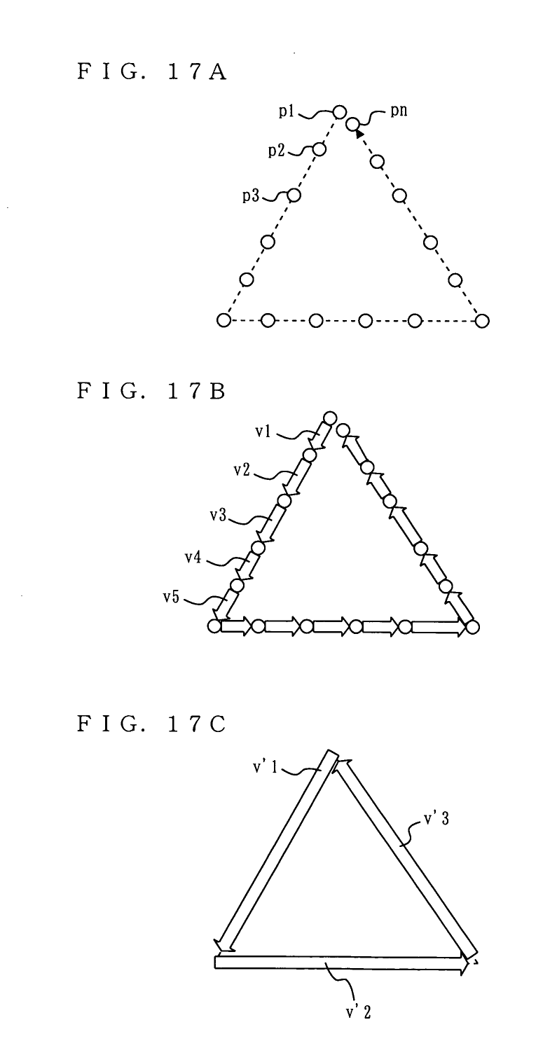

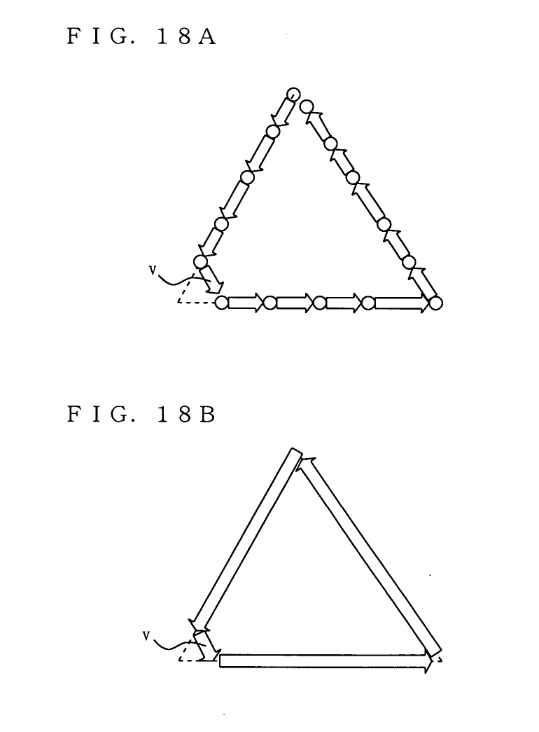

FIGS. 17A through 17C are diagrams used for explaining a process for simplifying the input coordinate list 22a. FIG. 17A is a diagram schematically showing a coordinate value group contained in the input coordinate list 22a. As described above, the input coordinate list 22a contains coordinate values indicating positions on the touch panel 13 which are detected at predetermined time intervals. In FIG. 17A, detection points p1, p2, and p3 each correspond to a coordinate value contained in the input coordinate list 22a. Note that dotted lines shown in FIG. 17A indicate the input trajectory. In the processes of steps S62 and S63, the vector data list 22b is initially generated based on the input coordinate list 22a.

FIG. 17B is a diagram schematically showing the vector data list 22b. The vector data list 22b contains a plurality of pieces of vector data each indicating a vector between adjacent detection points. For example, a vector v1 shown in FIG. 17B lies between the detection points p1 and p2. Note that each vector is obtained so as to point in a direction of the player's input operation, i.e., the vector is directed from a previously detected point to a later detected point. The vector data list 22b is generated by obtaining all the plurality of pieces of vector data between adjacent detection points (step S62). Note that in the illustrative embodiment, eight directions are represented by the plurality of pieces of vector data contained in the vector data list 22b. For example, although there might be a slight difference between a direction from the detection point p1 to the detection point p2 and a direction from the detection point p2 to the detection point p3, the vectors v1 and v2 are treated as the same direction because information related to directions are simplified when generating the vector data.

In the processes of steps S61 and S62, the input trajectory data 22c is then generated based on the vector data list 22b. Specifically, sequential pieces of vector data indicating the same direction and contained in the vector data list 22b are combined into one piece of vector data. FIG. 17C is a diagram schematically showing the input trajectory data 22c. Since vectors v1 through v5 shown in FIG. 17B have the same direction as each other, vectors v1 through v5 are combined into one piece of vector data. As a result, in FIG. 17C, one side of a triangular input trajectory is represented by one vector v′1. Similarly, in other sides of the triangular trajectory, vectors with the same direction are combined into one vector. As a result, the input trajectory data 22c represents an input trajectory with three pieces of vector data v′1 through v′3. Accordingly, based on the input trajectory data 22c containing the three pieces of vector data, it can be readily recognized that the input trajectory shown in FIG. 17A has a triangular shape. In this manner, through the processes of steps S62 and S63, it is possible to considerably simplify information representing the input trajectory, thereby making it possible to facilitate easy identification of the shape of the input trajectory.

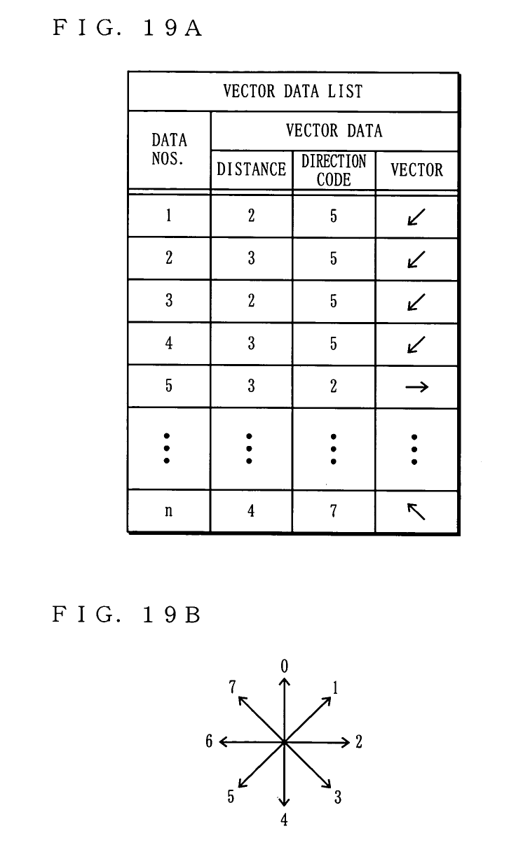

Note that if the time intervals of detecting an input to the touch panel 13 are relatively long, or if the speed at which the player moves his/her finger on the touch panel 13 is relatively fast, there is a possibility that a position of a vertex of the input trajectory might not be detected. In such a case, as shown in FIG. 18A, vector data v, which is inconsistent with an actual input trajectory (indicated by dotted lines), is obtained. Consequently, the input trajectory data 22c consists of four pieces of vector data (see FIG. 18B), and therefore the input trajectory might be misrecognized as a rectangle, for example. In order to prevent this, in addition to the processes of steps S62 and S63, a correction process may be performed for deleting vector data of less than a prescribed length from the vector data stored in the input trajectory data 22c. This deletes a piece of vector data, which is generated when a position of a vertex of the input trajectory is not detected and is inconsistent with an actual input trajectory, thereby preventing misrecognition of the shape of the input trajectory.

Referring back to FIG. 12, the detailed descriptions of the processes of steps S62 and S63 are provided below. In step S62, a piece of vector data indicating a vector between adjacent coordinate values is obtained based on the coordinate value group contained in the input coordinate list 22a (see FIG. 17B). The vector data list 22b is generated by obtaining each piece of vector data between adjacent detection points. Note that a piece of vector data between an i'th input coordinate value (where i is a natural number equal to or less than n-1) and an i+1'th input coordinate value is listed i'th in the vector data list 22b.

FIGS. 19A and 19B are diagrams used for explaining the vector data list 22b. Specifically, FIG. 19A shows an exemplary vector data list 22b obtained by performing the process of step S62. As described above, in the illustrative embodiment, directions of vectors are represented with eight directions. Specifically, the directions of the vectors are represented using direction codes 0 through 7 shown in FIG. 19B. The direction of a vector can be obtained based on coordinate values of adjacent detection points as described below. Consider a case where a coordinate value of a previously obtained detection point is represented by (x1,y1), and a coordinate value of a later obtained detection point is represented by (x2,y2), Rx=x2-x1, and Ry=y2-y1. If Ry<0 and |Ry|>2|Rx|, the direction code is 0 (an upward direction); if Rx>0, Ry<0, and 2|Rx|>=|Ry|>=|Rx|/2, the direction code is 1 (an upper right direction); if Rx>0 and |Rx|>2|Ry|, the direction code is 2 (a right direction); if Rx>0, Ry>0, and 2|Rx|>=|Ry|>=|Rx|/2, the direction code is 3 (a lower right direction); if Ry>0 and |Ry|>2|Rx|, the direction code is 4 (a downward direction); if Rx<0, Ry>0, and 2|Rx|>=|Ry|>=|Rx|/2, the direction code is 5 (a lower left direction); if Rx<0 and |RX|>2|Ry|, the direction code is 6 (a left direction); if Rx<0, Ry<0, and 2|Rx|>=|Ry|>=|Rx|/2, the direction code is 7 (an upper left direction). In this manner, the vector data can be represented with the above eight directions. This simplifies the shape of the input trajectory, and therefore it is possible to simplify a process for identifying the shape of the input trajectory (which will be described later in relation to step S64). Note that the top left corner of the display screen is at the origin, and a coordinate value increases as a distance from the origin increases on a side of the display screen.

Referring back to FIG. 12, following step S62, the process of step S63 is performed. Instep S63, the input trajectory data 22c is generated based on the vector data list 22b. Specifically, the input trajectory data 22c is generated by combining sequential pieces of vector data indicating the same direction and contained in the vector data list 22b. The sequential pieces of vector data indicating the same direction are shown in FIG. 19A as, for example, four pieces of vector data respectively specified by data nos. 1 through 4. These four pieces of vector data have the same direction code, and therefore can be combined into one piece of vector data. The distance of the combined vector data is equal to the sum of the distances of the four pieces of vector data. The direction of the combined vector data is naturally the same as the direction of the four pieces of vector data. As for vector data specified by data nos. 5 and greater, pieces of vector data indicating the same direction are similarly combined into one piece of vector data. Thus, the input trajectory data 22c as shown in FIG. 20 is obtained. In FIG. 20, vector data specified by data no. 1 (distance: 10; direction: 5) is obtained by combining the pieces of vector data specified by data nos. 1 through 4 contained in the vector data list 22b shown in FIG. 19A.

Following step S63, in step S64, the reference graphics database 22d is read from the WRAM 22. FIG. 21 is a diagram showing an exemplary reference graphics database 22d. As shown in FIG. 21, in the reference graphics database 22d, shapes of reference graphics and reference graphics data representing the shapes are associated with each other. Similar to the vector data list 22b and the input trajectory data 22c, a piece of the reference graphics data representing the shapes of the reference graphics consists of vector data. Note that the shape numbers shown in FIG. 21 correspond to the shape numbers shown in the item table (see FIG. 6A). In the illustrative embodiment, all sides of a reference graphic have a length of 1.

In step S65, a piece of reference graphics data, which represents a shape most analogous to a shape represented by the input trajectory data generated in step S63, is selected from the reference graphics data read in step S64. The shape represented by the reference graphics data selected in step S65 is identified as the shape of the input trajectory. The details of the process of step S65 are as follows below.

In step S65, similarity transformation is performed on the input trajectory data. In the similarity transformation, a graphic represented by the input trajectory data is enlarged or reduced so as to be almost equal in size to the reference graphic. In the illustrative embodiment, a magnification for enlargement or reduction is determined based on a piece of vector data indicating a minimum distance (hereinafter, referred to as “vector data A”) and a piece of vector data indicating a maximum distance (hereinafter, referred to as “vector data B”). Specifically, the magnification for enlargement or reduction is determined by (the magnification for enlargement or reduction)=(a distance indicated by the vector data A)/(a distance indicated by the vector data B). For example, consider a case where the similarity transformation is performed on the input trajectory data shown in FIG. 19A for comparison with the reference graphics data shown in FIG. 21. In this case, a minimum distance of vector data contained in the reference graphic data is 1, and a minimum distance of vector data contained in the input trajectory data is 10. Accordingly, the obtained magnification for enlargement or reduction is 1/10. Specifically, the vector data contained in the input trajectory data is reduced to 1/10, thereby obtaining a graphic represented by the input trajectory data which is almost equal in size to the reference graphic.

After the similarity transformation is performed on the input trajectory data, the input trajectory data is compared with the reference graphics data. For example, the comparison is performed using a dissimilarity value. The dissimilarity value indicates a degree of difference between the shape represented by the input trajectory data subjected to the similarity transformation and the shape represented by the reference graphics data. For example, the dissimilarity value is obtained by the following expression:
(the dissimilarity value)=(a difference in number of pieces of vector data)×10+(the number of different directions)×2+(sum of differences between distances)×1.
In the above expression, the difference in number of pieces of vector data corresponds to a difference between the number of pieces of vector data contained in the input trajectory data and the number of pieces of vector data contained in the reference graphics data. For example, the number of pieces of vector data contained in the input trajectory data shown in FIG. 20 is 3, and the number of pieces of vector data contained in the reference graphics data A (indicating a rightward straight line) shown in FIG. 21 is 1. Accordingly, in this case, the difference in number of pieces of vector data is 2.

The number of different directions corresponds to the number of differences between directions indicated by the vector data contained in the input trajectory data and directions indicated by the vector data contained in the reference graphics data. For example, comparing the input trajectory data shown in FIG. 20 and the reference graphics data A shown in FIG. 21, it is found that only vector data indicating a vector directed to the right (i.e., a piece of vector data specified by data no. 2 in FIG. 20 and a piece of vector data specified by data no. 1 in FIG. 21) are equal in direction to each other. No vector data contained in the reference graphics data shown in FIG. 21 indicates the same direction as the directions indicated by two other pieces of vector data contained in the input trajectory data shown in FIG. 20, and therefore the difference in number of directions is 2.

The sum of differences between distances corresponds to a sum of differences in distance between vector data contained in the input trajectory data and vector data contained in the reference graphics data. Specifically, a difference between two pieces of vector data specified by the same data number are obtained with respect to the vector data contained in the input trajectory data 22c and the reference graphics data. Further, the sum of differences obtained with respect to all data numbers is calculated. For example, comparing the input trajectory data (subjected to the similarity transformation) shown in FIG. 20 to the reference graphics data A shown in FIG. 21, it is found that distances indicated by the vector data are all 1 when a data number is one (j=1). Accordingly, the sum of differences of distances is 0. In this case, the reference graphic data A contains only one piece of vector data, and comparison of the vector data is carried out only when j=1. As a result, the sum of differences of distances is obtained as 0. Note that a difference of distances in the case where j=2 and a difference of distances in the case where j=3 may be added to the sum of differences of distances. In such a case, since the reference graphics data A does not contain any vector data corresponding to the case where j=2 or j=3, the distance of the vector data contained in the reference graphics data is considered to be 0 either in the case where j=2 or in the case where j=3. Accordingly, the sum of difference of distances is obtained as 2.

Note that in step S65, each piece of the reference graphics data is compared to the input trajectory data. Consequently, a piece of the reference graphics data having a minimum dissimilarity value is selected as representing a shape, which is most analogous to the shape represented by the input trajectory data. As such, steps S62 through S65 identify the shape of the input trajectory.

Note that in steps S62 through S65 as described above, the input trajectory data 22c is obtained and compared with the reference graphics data to identify the shape of the input trajectory. In other illustrative embodiments, the input coordinate list 22a may be compared with the reference graphics data to identify the shape of the input trajectory. In such a case, it is preferred that the reference graphics data consists of data indicating a coordinate value. Note that any method may be used for comparing the input coordinate list 22a with the reference graphics data. Also, in other illustrative embodiments, the vector data list 22b maybe compared with the reference graphics data to identify the shape of the input trajectory.

Following step S65, in step S66, an enemy character targeted for attack is selected based on the position of the input trajectory. Specifically, any enemy character, which is in contact with the input trajectory, is selected from among enemy characters contained in a game image. The selected enemy character is targeted for attack by the player character. Note that in addition to the enemy character which is in contact with the input trajectory, for example, any enemy character, which is enclosed by the input trajectory, may be targeted for attack.

In the following step S67, it is determined whether the enemy character selected in step S66 is present. If the enemy character selected in step S66 is not present, i.e., there is no enemy character which is in contact with the input trajectory, the procedure proceeds to step S68. Since there is no enemy character targeted for attack, an effect representation is presented in step S68 to show the failure of the attack, and the process shown in FIG. 13 is terminated.

Alternatively, if it is determined in step S67 that the enemy character selected in step S66 is present, the processes of steps S69 through S74 are performed. In the processes of steps S69 through S74, a degree of damage to be caused to the enemy character targeted for attack is determined. Firstly, in step S69, the degree of damage is determined based on a combination of the item type determined in step S46 and the input trajectory shape identified in step S65. The process of step S69 is carried out with reference to the above-described item table. Specifically, the item table 22e is referred to, to determine the effect of attack corresponding to the combination of the item type determined in step S46 and the input trajectory shape identified in step S65. Then, the degree of standard damage (predetermined for each weapon), which corresponds to the item type determined in step S46, is multiplied by a factor predetermined for each type of attack effects. A value obtained by the multiplication is set as the degree of damage to be caused to the enemy character.

Next, in step S70, an attribute and a vulnerable direction of the enemy character selected in step S66 are identified. The process of step S70 is performed based on the enemy character status table 22f. Specifically, the CPU core 21 reads the attribute and the vulnerable direction of the enemy character selected in step S66 from among data contained in the enemy character status table 22f.

Next, in step S71, the degree of damage determined in step S69 is adjusted based on the vulnerable direction identified in step S70. Specifically, the CPU core 21 initially identifies the input direction of the input trajectory. The input direction of the input trajectory is identified based on the direction of vector data contained in input trajectory data. Then, it is determined whether the identified input direction of the input trajectory is identical to the direction indicated by the vulnerable direction identified in step S70. If they are identical to each other, the degree of damage is adjusted. The adjustment of degree of damage is carried out by multiplying the degree of damage by a factor predetermined for the vulnerable direction identified in step S70. The result of the multiplication indicates the degree of damage after adjustment. For example, in the case where attack by thunder or the like (e.g., attack by the action of lightning cut with the weapon of a thunder sword) is performed on the enemy character A shown in FIG. 8, the degree of damage after adjustment is twice the degree of damage obtained in step S69. Note that in step S71, if the input direction of the input trajectory and the vulnerable direction are different from each other, the degree of damage is not adjusted.

Next, in step S72, the degree of damage is adjusted based on the enemy character's attribute identified in step S70. Specifically, it is determined whether the attack effect, which is determined based on the combination of the item type determined in step S46 and the input trajectory shape identified in step S65, is a special attack. In the case of the special attack, the correspondence between the special attack and the enemy character's attribute identified in step S70 is checked. If the enemy character has low resistance to the special attack, the degree of damage is multiplied by a factor predetermined for the attribute. A result of the multiplication indicates the degree of damage after adjustment. For example, in the case where attack by thrust up of spear (e.g., attack by the action of thrust up with the weapon of a spear) is performed on the enemy character B shown in FIG. 8, the degree of damage after adjustment is one and half times the degree of damage before adjustment. Note that in step S72, if the effect determined based on the above-described combination is not a special attack, and the enemy character's attribute is not associated with the special attack, the degree of damage is not adjusted.

Next, in step S73, an effect representation, which corresponds to the combination of the item type determined in step S46 and the input trajectory shape identified in step S56, is displayed on the display screen (see FIGS. 4A through 5B). Image data for the effect representation is previously stored for each combination of an item type and an input trajectory shape. In the following step S74, the CPU core 21 changes the enemy character's characteristic parameter (specifically, HP) in accordance with the degrees of the damage determined in steps S69, S71, and S72. Note that the enemy character having HP targeted for a change is in contact with the input trajectory, i.e., the enemy character is selected in step S66. Also, in step S74, the degree of damage to be changed is displayed as a damage representation on the first LCD 11 (see FIG. 4B). After step S74, the attack process shown in FIGS. 12 and 13 is terminated.

Referring back to FIG. 10, after step S47, the process of step S48 is performed. In step S48, it is determined whether a battle is completed. This determination is made based on, for example, whether the player character's HP or all enemy characters' HPs is/are reduced to zero. Specifically, if the player character's HP or all enemy characters' HPs is/are reduced to zero, it is determined that the battle is completed, and the battle process shown in FIG. 10 is terminated. On the other hand, if the player character's HP and any one enemy character's HP are not reduced to zero, it is determined that the battle is not completed, and the procedure returns to step S41. In this case, the processes of steps S41 through S48 are repeatedly performed until the battle is deemed to be completed. Thus, the description of the game process according to the illustrative embodiment has been completed.

As described above, in a touch-panel type game apparatus according to the illustrative embodiment, the style of attack and the degree of effect of the attack can be changed in accordance with an item type selected by the player and the shape of an input trajectory drawn on the display screen by the player's input. Accordingly, it is possible to provide a game which enables a wide variety of attack methods to be selected in a battle scene.

Although the illustrative embodiment has been described above with respect to operations of attacking enemy characters in battle scenes of an RPG, the present invention is not limited to such operations. For example, the present invention can be used in operations of recovering or protecting the player character. Specifically, it is conceivable that the type of a recovery operation (e.g., an operation of recovering HP, an operation of allowing the player character to recover from a poisoned state, etc.) and the degree of recovery (e.g., the amount of HP to be recovered) are changed in accordance with a combination of an item for recovering the player character's HP and an input trajectory shape.

Also, in other embodiments, damage to be caused may be changed in accordance with the number of enemy characters in contact with the input trajectory. For example, damage caused when only one enemy character is in contact with the input trajectory may be greater than damage caused when two enemy characters are in contact with the input trajectory. Also, in other embodiments, the damage to be caused to the enemy character may be changed in accordance with the size of the input trajectory.

Also, in the illustrative embodiment, one input trajectory is defined as a trajectory which consists of detection points detected within a predetermined time period after the detection of an input to the touch panel 13 in the player's attack operation (FIG. 14). In other embodiments, continuous inputs may be defined as one input trajectory. Specifically, one input coordinate list may consist of coordinate values detected while the player continuously provides inputs (for example, while the player's finger remains on the touch panel).

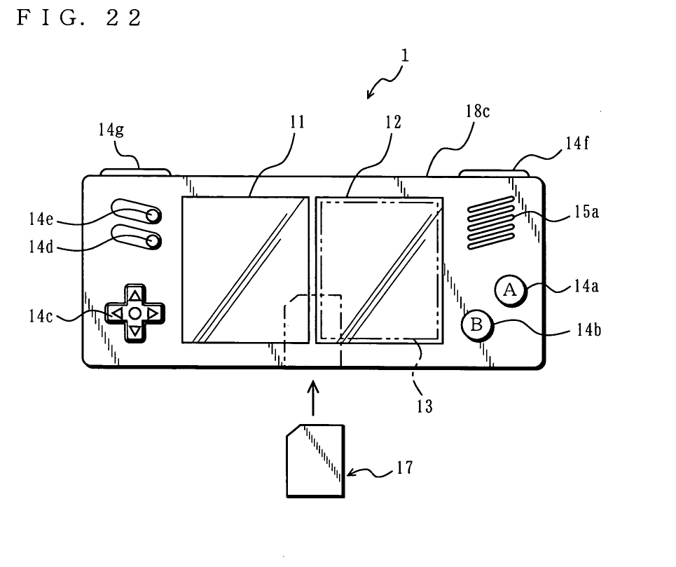

Note that although an exemplary liquid crystal display section for simultaneously displaying two separate images has been described above with respect to a case where the two LCDs 11 and 12 are arranged so as to be physically separated in a vertical direction (i.e., a case of two screens arranged in the vertical direction), the LCDs 11 and 12 may be arranged side by side in a horizontal direction without using the upper housing 18b as shown in FIG. 22. In order to arrange the LCDs 11 and 12 side by side in the horizontal direction, a housing 18c having a wide rectangular shape may be provided so as to accommodate the LCDs 11 and 12 therein. In such a case, it is preferred that the second LCD 12 having the touch panel 13 mounted thereon is located to the right of the LCD 11 with consideration that it is frequent for the users to be right-handed. However, the LCDs 11 and 12 may be arranged the other way around in a portable game apparatus for left-handed users.

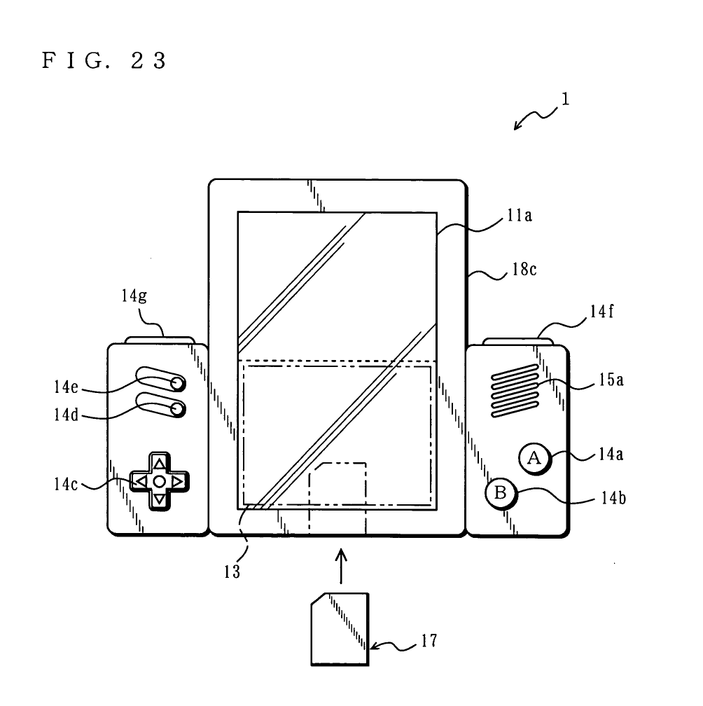

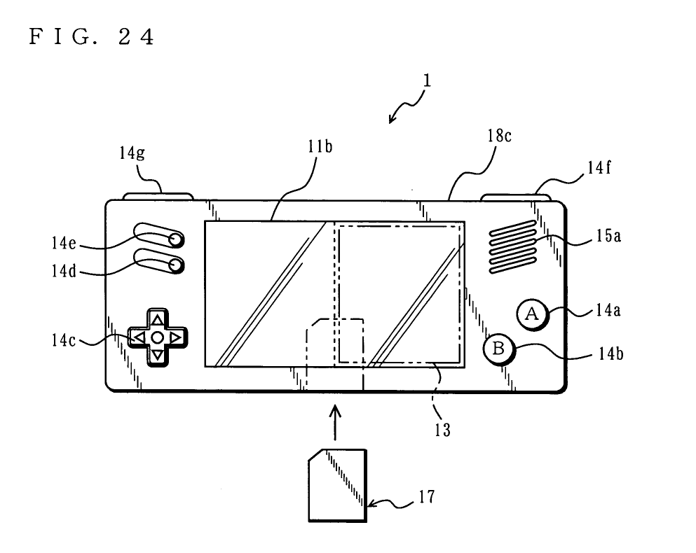

Further, instead of arranging the LCDs 11 and 12 so as to be physically separated in the vertical direction, an LCD 11a having a length twice the length of the LCD 11 and the same width as that of the LCD 11 as shown in FIG. 23 (i.e., the LCD 11a has physically one display screen having a size twice the size of the display screen of the LCD 11 in the vertical direction), may be provided so as to separately display two game images on the display screen (such that the two game images are adjacent to each other without a gap in between them in the vertical direction). Alternatively, an LCD 11b having a width twice the width of the LCD 11 and the same length as that of the LCD 11 as shown in FIG. 24 (i.e., the LCD 11b has physically one display screen having a size twice the size of the display screen of the LCD 11 in the horizontal direction), maybe provided so as to separately display two game images on the display screen (such that the two game images are adjacent to each other without a gap in between them in the horizontal direction). In the examples of FIGS. 23 and 24, a display screen, which is physically one unit, is divided into two sections so as to display a plurality of game images thereon.

While the invention has been described in detail, the foregoing description is in all aspects illustrative and not restrictive. It is understood that numerous other modifications and variations can be devised without departing from the scope of the invention.

1. A computer-readable storage medium having a game program stored therein, the game program causing a computer of a game apparatus, which includes a display screen for displaying a game image and a touch panel provided on the display screen, to implement:
a game image display step of allowing a game image, which contains one or more game character images showing a game character and item images each showing an item, to be displayed on the display screen;
an item determination step of determining an item type by causing a player to select at least one item image displayed on the display screen;
a coordinate detection step of detecting a coordinate value at predetermined time intervals, the coordinate value indicating a position on the touch panel where the player's input is provided;
a shape identification step of identifying a graphical shape of an input trajectory represented by a coordinate value group detected by the coordinate detection step; and
a characteristic parameter change step of changing a process detail for changing a characteristic parameter, which indicates a characteristic of the game character, in accordance with a combination of the item type determined by the item determination step and the graphical shape of the input trajectory identified by the shape identification step.

2. The storage medium according to claim 1, wherein the game program further causes the computer to implement a change representation addition step of introducing a change to the game image in accordance with the combination when the characteristic parameter is changed by the characteristic parameter change step.

3. The storage medium according to claim 1,
wherein the coordinate detection step detects the coordinate value at predetermined time intervals within a predetermined time period after the player's input is started, and
wherein the shape identification step identifies the graphical shape of the input trajectory based on a unit of the coordinate value group detected by the coordinate detection step within the predetermined time period.

4. The storage medium according to claim 3, wherein if the graphical shape of the input trajectory identified by the shape identification step is a first shape, the characteristic parameter change step changes the characteristic parameter by a first amount of change, and if the graphical shape of the input trajectory is a second shape which is more complicated than the first shape, the characteristic parameter change step changes the characteristic parameter by a second amount of change which is greater than the first amount of change.

5. The storage medium according to claim 1,
wherein the shape identification step obtains an input direction of the input trajectory on the game character, and
wherein the characteristic parameter change step changes a degree of change of the characteristic parameter in accordance with the input direction of the input trajectory.

6. The storage medium according to claim 1,
wherein the game program further causes the computer to implement a character selection step of selecting a game character having a characteristic parameter to be changed, from among one or more game characters contained in the game image, based on relationships between a position of the input trajectory on the touch panel and positions of the one or more game characters, and
wherein the characteristic parameter change step changes only the characteristic parameter of the game character selected by the character selection step.

7. A game apparatus having a display screen for displaying a game image and a touch panel provided on the display screen, the game apparatus comprising:
a game image display control unit for allowing a game image, which contains one or more game character images showing a game character and item images each showing an item, to be displayed on the display screen;
an item determination unit for determining an item type by causing a player to select at least one item image displayed on the display screen;
a coordinate detection unit for detecting a coordinate value at predetermined time intervals, the coordinate value indicating a position on the touch panel where the player's input is provided;
a shape identification unit for identifying a graphical shape of an input trajectory represented by a coordinate value group detected by the coordinate detection step; and
a characteristic parameter change unit for changing a process detail for changing a characteristic parameter, which indicates a characteristic of the game character, in accordance with a combination of the item type determined by the item determination step and the graphical shape of the input trajectory identified by the shape identification step.
